(19) United States
(12) Patent Application Publication
(10) Pub. No.: US 2006/0216574 A1
(43) Pub. Date: Sep. 28, 2006

(54) Fuel battery

(75) Inventors: Kensuke Yoshida, Kawasaki (JP); Fumio Takei, Kawasaki (JP); Masami Tsutsumi, Kawasaki (JP); Hiroaki Yoshida, Kawasaki (JP); Youichi Takasu, Kawasaki (JP); Nawalage Florence Cooray, Kawasaki (JP); Seiji Hibino, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/443,122

(22) Filed: May 31, 2006

Related U.S. Application Data
(63) Continuation of application No. PCT/JP04/11781, filed on Aug. 17, 2004.

(30) Foreign Application Priority Data
Feb. 24, 2004 (JP) 2004-048125

(51) Int. Cl. H01M 8/24; H01M 8/02

(52) U.S. Cl. 429/38; 429/39

(57) ABSTRACT

A fuel battery 20 includes a fuel supplier 32, and a battery cell structure 31A and a battery cell structure 31B which are arranged to face each other respectively and to sandwich the fuel supplier 32, and in the battery cell structure 31A and the battery cell structure 31B, fuel battery cells CA1 through CA6, and CB1 through CB6 are arranged. Due to separators 40a and 40b, in the battery cell structure 31A, from the fuel electrode of the fuel battery cell CA1 to the air electrode of the fuel battery cell CA6, and in the battery cell structure 31B, from the fuel electrode of the fuel battery cell CB6 to the air electrode of the fuel battery cell CB1, are electrically connected in series. With the cell connector 35, the air electrodes of the fuel battery cells on the diagonal lines of the battery cell structure 31A and the battery cell structure 31B are connected electrically in parallel. Even when the surface of the liquid fuel filling the fuel supplier 32 changes, and some fuel battery cells stop electricity generation, the counterpart fuel battery cells connected in parallel can generate electricity. As a result, it is possible to easily make the fuel battery compact and light, and to prevent stoppage of power supply under various usage conditions of the fuel battery for stable power supply. Disclosure is also made of a fuel battery in which fuel battery cells facing each other are arranged to be perpendicular to each other.

### CROSS-REFERENCE TO RELATED APPLICATION

This application is a U.S. continuation application filed under 35 USC 111(a) claiming benefit under 35 USC 120 and 365(c) of PCT application JP2004/011781, filed Aug. 17, 2004, which is based on Japanese priority patent application No. 2004-048125 filed on Feb. 24, 2004. The entire contents of these applications are hereby incorporated herein by reference.

### BACKGROUND OF THE INVENTION

1. Field of the Invention

The present invention relates to a fuel battery, and particularly, to a fuel battery including plural fuel battery cells as component units, the fuel battery cells being connected to increase an output voltage of the fuel battery.

2. Description of the Related Art

In recent years, portable information processing devices have become more compact, light, fast, and of multiple functions. Along with the progress in the portable information processing devices, the batteries, which serve as the power supply of the portable information processing devices, are also becoming more compact, light, and of high capacity.

In the current portable information processing devices, such as cellular phones or portable computer systems (specifically, a notebook personal computer), the most frequently used power supply is a lithium-ion battery. The lithium-ion battery has a high driving voltage and a high capacity from the early time of its practical usage, and its performance has been improved along with the progress made in the portable information processing devices. However, further improvement of the performance of the lithium-ion battery has limits, and the lithium-ion battery is becoming unable to satisfy the requirements as a power supply of increasingly improving portable information processing devices.

Under this circumference, it is expected that there will be developed a new power supplying device to replace the lithium-ion battery. One of the candidates is a fuel battery. The fuel battery supplies a fuel to a cathode thereof to generate electrons and protons, and the protons are brought into reactions with oxygen supplied to an anode of the fuel battery, thereby, generating electricity. The most noticeable feature of the system is that it can generate electricity continuously for a long time by supplementing the fuel and oxygen, and thus it can be used as a power supply of a device as a secondary battery by fuel supplementation instead of charging the secondary battery. In addition, if converting to active materials, the theoretical energy density of the methanol is about 10 times higher than that of the lithium-ion battery, and thus, it is possible to make the fuel battery very small and light. For the above reasons, extensive studies have been made of the fuel battery for use not only as a distributed power supply or a large-scale power generator of an electrical automobile, but also as a highly compact power generator suitable for a notebook personal computer or a cellular phone.

Particularly, in the field of the compact fuel battery, studies are focused on a so-called direct methanol fuel battery cell (DMFC), which uses a methanol water solution as the fuel. In a DMFC, the component unit of the fuel battery, namely, a fuel battery cell, is formed from a fuel electrode catalyst layer, a solid electrolyte film, an air electrode catalyst layer, and current collectors arranged to sandwich the above components. The fuel electrode catalyst layer and the air electrode catalyst layer are primarily formed from an electrode catalyst which includes platinum-family super fine particles fixed on a surface of a carbon-family carrier. The polymer solid electrolyte is formed from materials which are solid at an ordinary temperature but allow penetration and transportation of protons like an electrolytic solution. The fuel battery cell forms a thin sheet including stacked layers of the above materials. On the side of the fuel electrode, there is a fuel storage portion in the fuel battery cell, which is designed to allow a certain amount of fuel to be in contact with the fuel electrode.

In a DMFC, usually, the output voltage of the fuel battery cell is below 0.8 V, and usually depends on an output current thereof, for example, in a range from 0.3 V to 0.6 V. On the other hand, the operational voltage of the portable information processing device is in a range from about 1.5 V to about 12 V, which is much greater than the output voltage of the fuel battery cell. For this reason, in order to drive the portable information processing device, it is proposed to connect the fuel electrodes and the air electrodes of plural fuel battery cells in series to heighten the output voltage. For example, as for a fuel battery using a hydrogen fuel, a fuel battery is proposed in which plural cells are arranged in a plane and are electrically connected in series to heighten the output voltage (For example, please refer to Japanese Laid Open Patent Application No. 5-325993).

For a hydrogen fuel battery, the hydrogen gas, which is the fuel, can be easily supplied to the fuel electrode by just controlling its pressure and flow rate with a mass flow meter because of little influence from gravity.

When using the methanol fuel, however, because of the influence of gravity, the fuel is always located in the lower part of the fuel storage portion, hence, among the cells in connection, probably, the fuel electrodes of some cells are not immersed in the fuel. In this case, if just connecting the cells in series, supply of power may be stopped by the cells which do not generate electricity.

Particularly, when using a fuel battery as a power supply of a portable terminal device, because the surface of the liquid fuel in the fuel storage portion moves in three dimensions during the carrying of the portable terminal device, because of lack of the primary fuel, some fuel battery cells are apt to stop power supply, and in this case, the whole fuel battery stops power supply, and the operations of the portable terminal device stop instantaneously; this may destroy data or other information.

In addition, in order to supply the fuel sequentially, and to fully fill the fuel storage portion with the fuel constantly, a complicated mechanism has to be used, and thus the weight of the fuel battery increases, making it difficult to reduce the size, weight, and cost of the fuel battery.

### SUMMARY OF THE INVENTION

A general object of the present invention is to solve the above problems and provide a novel and useful fuel battery.

A specific object of the present invention is to provide a fuel battery able to be made small and light easily, and able to prevent stoppage of power supply under various usage conditions of the fuel battery for stable power supply.

According to an aspect of the present invention, there is provided a fuel battery, comprising:

a plurality of fuel battery cells each including a fuel electrode, a solid electrolyte, and an air electrode; and

a fuel supplier that is filled with a liquid fuel and supplies the fuel electrode with the liquid fuel,

wherein

a first battery cell structure and a second battery cell structure are formed on a first surface and a second surface constituting the fuel supplier, each of the first battery cell structure and the second battery cell structure includes n said fuel battery cells arranged from one end of the fuel supplier to another end of the fuel supplier,

in the first battery cell structure, the fuel battery cells are electrically connected in series in order of the arrangement so that the fuel electrode of the fuel battery cell on the one end serves as an output side of the first battery cell structure, and the air electrode of the fuel battery cell on the other end serves as a grounding side of the first battery cell structure,

in the second battery cell structure, the fuel battery cells are electrically connected in series in order opposite to said arrangement order so that the fuel electrode of the fuel battery cell on the other end serves as an output side of the second battery cell structure, and the air electrode of the fuel battery cell on the one end serves as a grounding side of the second battery cell structure,

the first battery cell structure and the second battery cell structure are electrically connected in parallel, and

a connector for electrically connecting an m-th fuel battery cell and an (m+1)-th fuel battery cell from the one end of the first battery cell structure is electrically connected with a connector for electrically connecting an m-th fuel battery cell and an (m+1)-th fuel battery cell from the other end of the second battery cell structure, where n is an integer equal to or greater than 2, and m is an integer having at least one value from 1 to n−1.

According to the present invention, on the first surface and the second surface of the fuel supplier filled with the liquid fuel, a first battery cell structure and a second battery cell structure are provided, and each of the first battery cell structure and the second battery cell structure includes n fuel battery cells, which are electricity generation units. The n fuel battery cells are arranged from one end of the fuel supplier to another end of the fuel supplier. In the first battery cell structure on the first surface, the n fuel battery cells are electrically connected in series in order of the arrangement. Due to this structure, the fuel electrode of the fuel battery cell on one end serves as an output side of the first battery cell structure, and the air electrode of the fuel battery cell on another end serves as a grounding side of the first battery cell structure. On the other hand, in the second battery cell structure on the second surface, the n fuel battery cells are electrically connected in series in order opposite to the arrangement order so that the fuel electrode of the fuel battery cell on the other end serves as an output side of the second battery cell structure, and the air electrode of the fuel battery cell on the one end serves as a grounding side of the second battery cell structure. It should be noted that in a serial connection, the output voltages of the fuel battery cells are summed. In addition, the first battery cell structure and the second battery cell structure are electrically connected in parallel. Further, with m being an integer equaling one of 1, 2, . . . , n−1, a connector for electrically connecting the m-th fuel battery cell and the (m+1)-th fuel battery cell from one end of the first battery cell structure is electrically connected with a connector for electrically connecting the m-th fuel battery cell and the (m+1)-th fuel battery cell from another end of the second battery cell structure. Namely, for example, when m=1, a connector between the fuel battery cell on one end of the first surface and the next fuel battery cell is electrically connected with a connector on a diagonal line between the fuel battery cell on the other end of the second surface and the next fuel battery cell.

In this way, since the fuel battery cells in the first battery cell structure and the second battery cell structure are electrically connected in series, respectively, an output voltage is obtainable which equals the summation of the output voltages of the fuel battery cells. In addition, since the connectors of the first battery cell structure are electrically connected with the connectors of the second battery cell structure, even when the surface of the liquid fuel filling in the fuel supplier changes due to installation conditions of the fuel batteries, carrying posture, or vibration, and thus the fuel cannot be supplied to the fuel electrode partially or completely in some fuel battery cells among the n fuel battery cells, because the fuel battery cells electrically connected with the fuel battery cells in trouble in parallel are located on the diagonal line with the fuel supplier in between, fuel electrodes of those fuel battery cells are in contact with the fuel, and thus, those fuel battery cells can generate electricity. As a result, it is possible to prevent stoppage of power supply of the fuel battery, or to prevent lowering of output power, and enable stable power supply.

In addition, the connector between the m-th fuel battery cell and the (m+1)-th fuel battery cell from one end of the first battery cell structure may be electrically connected with the connector between the m-th fuel battery cell and the (m+1)-th fuel battery cell from another end of the second battery cell structure for any value of m in the range from 1 to n−1.

Because the fuel battery cells in the first battery cell structure are respectively electrically connected with the fuel battery cells in the second battery cell structure in parallel, even when the output electricity of one of the fuel battery cells connected in parallel diminishes or vanishes, other fuel battery cells are not influenced. This improves the fuel utilization and enables more stable power supply.

The fuel supplier may be of a flat rectangular solid shape in a thickness direction of the fuel supplier, and the first battery cell structure and the second battery cell structure are located to face each other in the thickness direction. Due to this, the total area of the fuel battery cells can be increased, and it is possible to make the fuel battery compact.

A gas exhaust part formed from a gas permeable film may be provided on each side surface of the first battery cell structure, the second battery cell structure, and the fuel supplier to isolate a liquid fuel side from an external gas side. The gas exhaust part may be arranged to be near two ends of each side surface of the first battery cell structure, the second battery cell structure, and the fuel supplier in a longitudinal direction.

Because of the thus arranged gas exhaust part, no matter what posture the fuel battery has, there is at least one gas exhaust part located in the space of the fuel supplier, which is filled with CO₂ gas generated by electricity generation reactions of the fuel electrode, the CO₂ gas can be exhausted smoothly through the gas permeable film to the external gas side, hence, it is possible to reduce the pressure in the fuel supplier. In addition, since the gas permeable film is not permeable to the liquid fuel, it is possible to prevent fuel leakage. Consequently, it is possible to prevent deformation of the fuel supplier or the fuel battery cells due to an increased pressure, and improve long-term reliability.

The gas permeable film may be of water repellency. Due to this, it is possible to prevent adhesion of water generated by the electricity generation reactions at the air electrode to the gas permeable film, enabling smooth exhaust of the CO₂ gas.

The connector includes a separator for connecting adjacent fuel battery cells, one end of the separator may be in contact with the fuel electrode or the air electrode of one of the adjacent fuel battery cells, and the other end of the separator is in contact with the air electrode or the fuel electrode of the other one of the adjacent fuel battery cells for electrical connection.

By using the separator, adjacent fuel battery cells are connected by only one part, thus, the number of parts can be reduced, the gap between the fuel battery cells can be reduced, and this makes the fuel battery compact.

In addition, the separator may be formed from a plate-like material, and a cross section of the separator may be of a Z-shape in the arrangement direction.

Because of usage of the plate-like material, it is possible to increase the cross-sectional area of the current path, reduce the connection resistance between the fuel battery cells, and reduce the voltage drop.

The fuel battery may further comprise a ring-shaped sealing member that encloses a stack structure of the fuel electrode, the solid electrolyte, and the air electrode, and is sandwiched by two separators from the fuel electrode side and the air electrode side.

Due to this, it is possible to prevent leakage of the liquid fuel, and prevent a short circuit between the separators.

In addition, the fuel battery may further comprise a plate-like sealing member that separates an adjacent two of the separators.

Due to this, it is possible to prevent a short circuit between the separators, and to apply stress in a direction of sandwiching the sealing member to fix the adjacent fuel battery cells, thus improving the mechanical strength of the fuel battery.

According to another aspect of the present invention, there is provided a fuel battery, comprising:

a plurality of fuel battery cells each including a fuel electrode, a solid electrolyte, and an air electrode; and

a fuel supplier that is filled with a liquid fuel and supplies the fuel electrode with the liquid fuel,

wherein

a first battery cell structure and a second battery cell structure are formed on a first surface and a second surface constituting the fuel supplier, and each of the first battery cell structure and the second battery cell structure includes n said fuel battery cells,

in the first battery cell structure, the n fuel battery cells are arranged from a first end of the fuel supplier to a second end of the fuel supplier opposite to the first end,

in the second battery cell structure, the n fuel battery cells are arranged from a third end of the fuel supplier to a fourth end of the fuel supplier opposite to the third end in a direction perpendicular to an arrangement direction of the fuel battery cells in the first battery cell structure,

in the first battery cell structure, the fuel battery cells are electrically connected in series in order of the arrangement so that the fuel electrode of the fuel battery cell on the first end side serves as an output side of the first battery cell structure, and the air electrode of the fuel battery cell on the second end side serves as a grounding side of the first battery cell structure,

in the second battery cell structure, the fuel battery cells are electrically connected in series in order of the arrangement so that the fuel electrode of the fuel battery cell on the third end side serves as an output side of the second battery cell structure, and the air electrode of the fuel battery cell on the fourth end side serves as a grounding side of the second battery cell structure, and

a connector for electrically connecting an m-th fuel battery cell and an (m+1)-th fuel battery cell from the first end of the first battery cell structure is electrically connected with a connector for electrically connecting an m-th fuel battery cell and an (m+1)-th fuel battery cell from the third end of the second battery cell structure, where n is an integer equal to or greater than 2, and m is an integer having at least one value from 1 to n−1.

The above present invention has the same advantages as the previous inventions. Furthermore, even when the liquid fuel filling the fuel supplier is reduced, or even when the surface of the liquid fuel filling the fuel supplier changes due to installation conditions of the fuel batteries, carrying posture, or vibration, at least one of the fuel battery cells electrically connected in parallel is located with its fuel electrode being in contact with the fuel, and the fuel battery cell can generate electricity. Thus, because the fuel battery cells in parallel to each other are electrically connected in series in the fuel battery, the fuel battery can generate and supply power. As a result, it is possible to prevent stoppage of power supply of the fuel battery caused by orientation of the fuel batteries or vibration, or to prevent lowering of output power, enabling stable power supply.

### BRIEF DESCRIPTION OF THE DRAWINGS

These and other objects, features, and advantages of the present invention will become more apparent with reference to the following drawings accompanying the detailed description of the present invention, in which:

FIG. 1 is a perspective view of a portable terminal device including a fuel battery according to a first embodiment of the present invention;

FIG. 2 is a cross-sectional view of the portable terminal device in FIG. 1;

FIG. 3 is a block diagram illustrating power supplying operations;

FIG. 4 is a perspective view of the fuel battery according to the first embodiment of the present invention;

FIG. 5 is an enlarged cross-sectional view of one gas exhaust part 34;

FIG. 6 is a plan view of the battery cell structure 31A;

FIG. 7 is an enlarged cross-sectional view of the battery cell structure 31A;

FIG. 8 is an enlarged cross-sectional view of the cell structure unit 41;

FIG. 9 is an exploded perspective view of the battery cell structure 31A;

FIG. 10A is a side view for illustrating a connection condition of the fuel battery cells CA and CB;

FIG. 10B is an exploded side view of leads for connecting the fuel battery cells CA and CB;

FIG. 11 illustrates an equivalent circuit of the fuel battery 20;

FIG. 12A and FIG. 12B are views illustrating the relation between the posture of the fuel battery 20 and the surface of the liquid fuel in the fuel supplier 32;

FIG. 13A is a schematic view illustrating the fuel battery of the present embodiment;

FIG. 13B illustrates an equivalent circuit of the fuel battery in FIG. 13A;

FIG. 13C illustrates an equivalent circuit of the fuel battery to which the present invention is not applied;

FIG. 14A through FIG. 14C are circuit diagrams illustrating equivalent circuits of the fuel batteries as modifications of the first embodiment;

FIG. 15A through FIG. 15D are circuit diagrams illustrating equivalent circuits of the fuel batteries as modifications of the first embodiment;

FIG. 16 is an exploded perspective view of a fuel battery 60 according to a second embodiment of the present invention;

FIG. 17 is a circuit diagram illustrating an equivalent circuit of the fuel battery 60;

FIG. 18A through FIG. 18C are circuit diagrams illustrating equivalent circuits of the fuel batteries as a first modification of the second embodiment;

FIG. 19A through FIG. 19D are circuit diagrams illustrating equivalent circuits of the fuel batteries as a second modification of the second embodiment;

FIG. 20A includes a schematic view illustrating the fuel battery of the second embodiment and a circuit diagram of the equivalent circuit of the fuel battery (example 1);

FIG. 20B includes a schematic view illustrating the fuel battery of the first embodiment and a circuit diagram of the equivalent circuit of the fuel battery (example 2);

FIG. 20C includes a schematic view illustrating a fuel battery to which the present invention is not applied (as an example for comparison) and a circuit diagram of the equivalent circuit of the fuel battery (example for comparison 1);

FIG. 21 is a table exemplifying a relationship between the tilt angle θ and the output voltage of the fuel battery;

FIG. 22 is an exploded perspective view of a fuel battery 80 according to a third embodiment of the present invention;

FIG. 23 is a circuit diagram illustrating an equivalent circuit of the fuel battery 80;

FIG. 24A includes a schematic view illustrating the fuel battery of the third embodiment and a circuit diagram of the equivalent circuit of the fuel battery as an example 3;

FIG. 24B includes a schematic view illustrating the fuel battery of the first embodiment and a circuit diagram of the equivalent circuit of the fuel battery as an example 4;

FIG. 25 includes a schematic view illustrating a fuel battery to which the present invention is not applied and a circuit diagram of the equivalent circuit of the fuel battery as an example for comparison 2; and

FIG. 26 is a table exemplifying a relationship between the tilt angle θ and the output voltage of the fuel battery.

### DESCRIPTION OF THE PREFERRED EMBODIMENTS

Below, embodiments of a fuel battery of the present invention are explained with reference to the accompanying drawings.

### First Embodiment

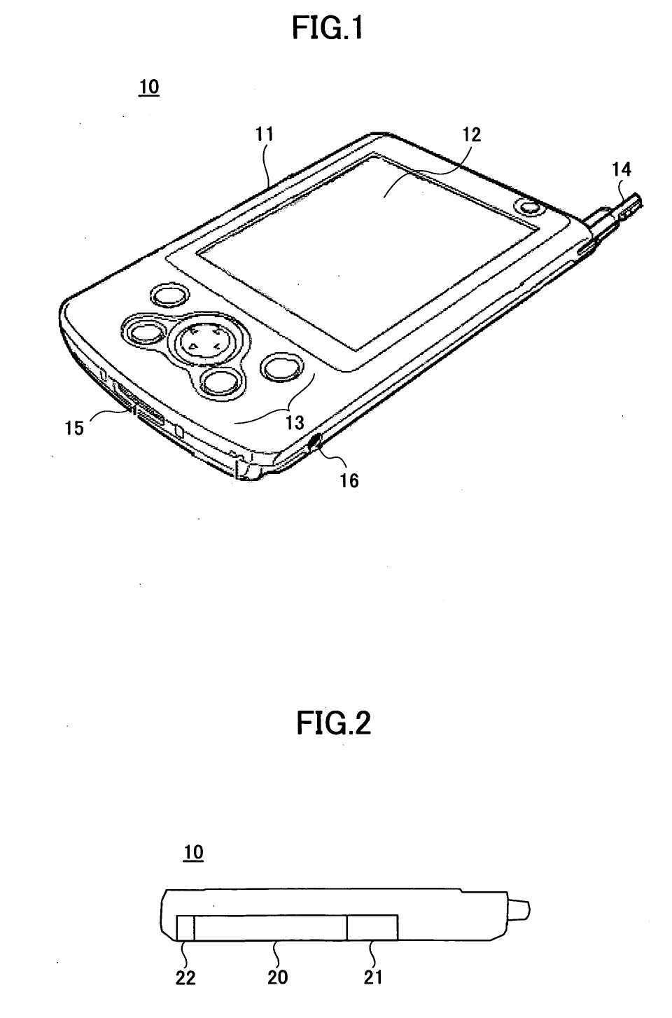

FIG. 1 is a perspective view of a portable terminal device including a fuel battery according to a first embodiment of the present invention.

FIG. 2 is a cross-sectional view of the portable terminal device in FIG. 1.

Referring to FIG. 1 and FIG. 2, a portable terminal device 10 includes a housing 11, a display portion 12 arranged in the front side of the housing 11 and also serving as a pen input unit, an operational portion 13 such as operational buttons or cursor buttons, a pen 14 for input, a connector 15 on the bottom or the side surface of the housing 11 for connection with an external apparatus, a connector 16 for connection to an external power supply, a fuel battery 20 arranged on the back side of the housing 11 for supplying electrical power, a fuel cartridge 21, and a booster circuit 22. Although not illustrated, circuits which enable functions of the portable terminal device 10 such as a CPU, a memory, and other peripheral circuits, and secondary batteries such as lithium-ion batteries are installed in the housing 11.

When operating the portable terminal device 10, a user holds and tilts the housing 11 with two hands, presses the operational buttons with his thumb while viewing an image on the display portion 12, holds the housing 11 with one hand, and inputs information by using the pen 14 with the other hand, presses the display portion 12, which also acts as an input pad, with a finger, or reads information displayed on the display portion 12. Sometimes, the portable terminal device 10 can be operated while moving. As described below in detail, the fuel battery 20 of the present embodiment is capable of stable power supply even under such a condition.

The fuel battery 20, together with the fuel cartridge 21, is attached to the back side of the housing 11, and the fuel battery 20 is supplied with the fuel, such as the methanol water solution, from the fuel cartridge 21 to generate electricity, thus functioning as a power supply source. Although not illustrated, many ventilation holes are formed on the back side of the housing 11. This is for smoothly circulating air consumed by the fuel battery 20, produced CO₂ gas, or water vapor.

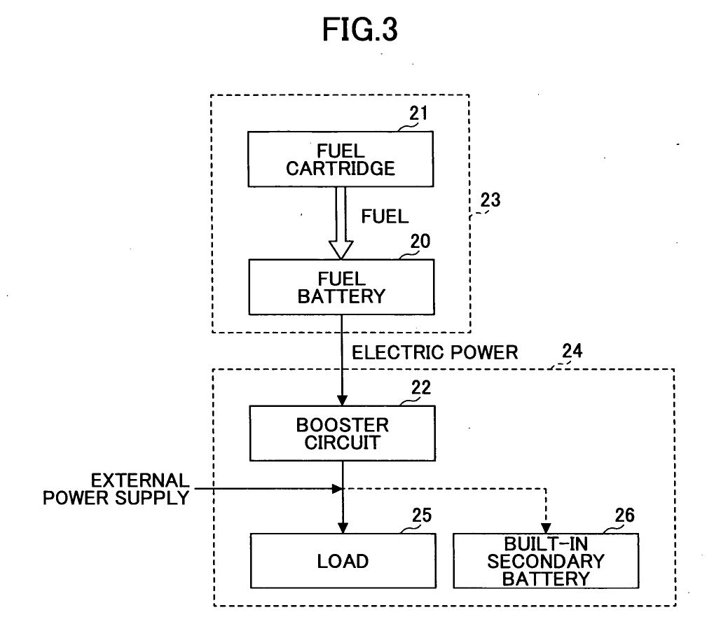

FIG. 3 is a block diagram illustrating power supplying operations.

As shown in FIG. 3, a power supplier 23 includes the fuel cartridge 21 which is filled with a fuel such as a methanol water solution, and the fuel battery 20 which uses the fuel supplied from the fuel cartridge 21 to generate electricity. A main body 24 includes the booster circuit 22 which steps up the voltage output from the fuel battery 20 so as to drive a load 25, the load 25 which receives power from the booster circuit 22 and performs various functions of the portable terminal device 10, and a built-in secondary battery 26 such as a lithium-ion battery for charging. The electricity is supplied to the load 25 or the built-in secondary battery 26 from the external power supply.

The fuel cartridge 21 may be formed from plastic the plastic having resistance against methanol, such as polyethylene, polypropylene, or other polyolefins, PTFE, PFA, or other fluororesins, polyvinyl chloride, poly(butylene terephthalate), polyethylene naphthalate, polyether sulfone, polysulfone, polyphenyleneoxide, polyether ether ketone, or other resins. For example, the fuel cartridge 21 may be formed from the same material as that of the housing of a fuel supplier 32, as described below.

The fuel in the fuel cartridge 21 is supplied through a fuel injection channel between the fuel battery 20 and the fuel cartridge 21. For example, the fuel can be fed by shaking the portable terminal device 10 with hands. This is preferable because it is simple and does not consume power. Of course, a solenoid, a diaphragm, a varistor, or other mini-pumps may be arranged in the fuel injection channel to feed the fuel to the fuel battery 20 gradually.

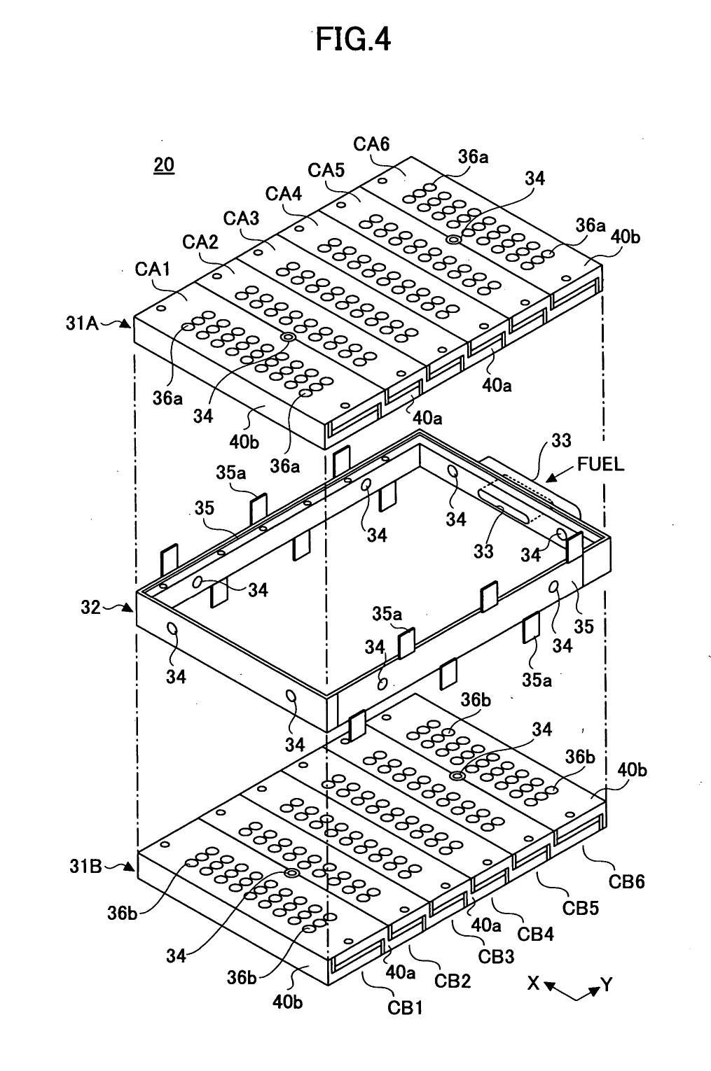

FIG. 4 is an exploded perspective view of the fuel battery according to the first embodiment of the present invention. As shown in FIG. 4, briefly speaking, the fuel battery 20 includes the fuel supplier 32, a battery cell structure 31A and a battery cell structure 31B which are arranged to face each other respectively to sandwich the fuel supplier 32, and in the battery cell structure 31A and the battery cell structure 31B, fuel battery cells CA1 through CA6, and CB1 through CB6 are arranged.

The fuel supplier 32 has a frame-like plastic housing having openings on the sides where the battery cell structure 31A and the battery cell structure 31B are attached. On the side surface of the fuel supplier 32, there are formed the fuel injection channel 33 for the fuel cartridge 21 (not illustrated in FIG. 4) to feed the fuel, gas exhaust parts 34 for exhausting the CO₂ gas generated by fuel electrodes as described below, and cell connectors 35 for electrically connecting the fuel battery cells CA and CB.

Preferably, the housing of the fuel supplier 32 is formed from materials which materials have resistance against alcohol, such as methanol, for example, polyethylene, polypropylene, or other polyolefins, PTFE, PFA, or other fluororesin, polyvinyl chloride, poly(butylene terephthalate), polyethylene naphthalate, polyether sulfone, polysulfone, polyphenyleneoxide, polyether ether ketone, or other resins.

The fuel injection channel 33 is connected to the not-illustrated fuel cartridge 21. For example, the cross section of the fuel injection channel 33 may be of a prolate elliptical shape. This is preferable because a sufficient cross sectional-area is obtainable even though the thickness of the fuel supplier 32 is limited in the compact fuel battery 20, and this facilitates temporary introduction of the fuel from the fuel cartridge 21. Additionally, a valve or other fuel blocking members may be the fuel injection channel 33 to prevent back-flow of the fuel.

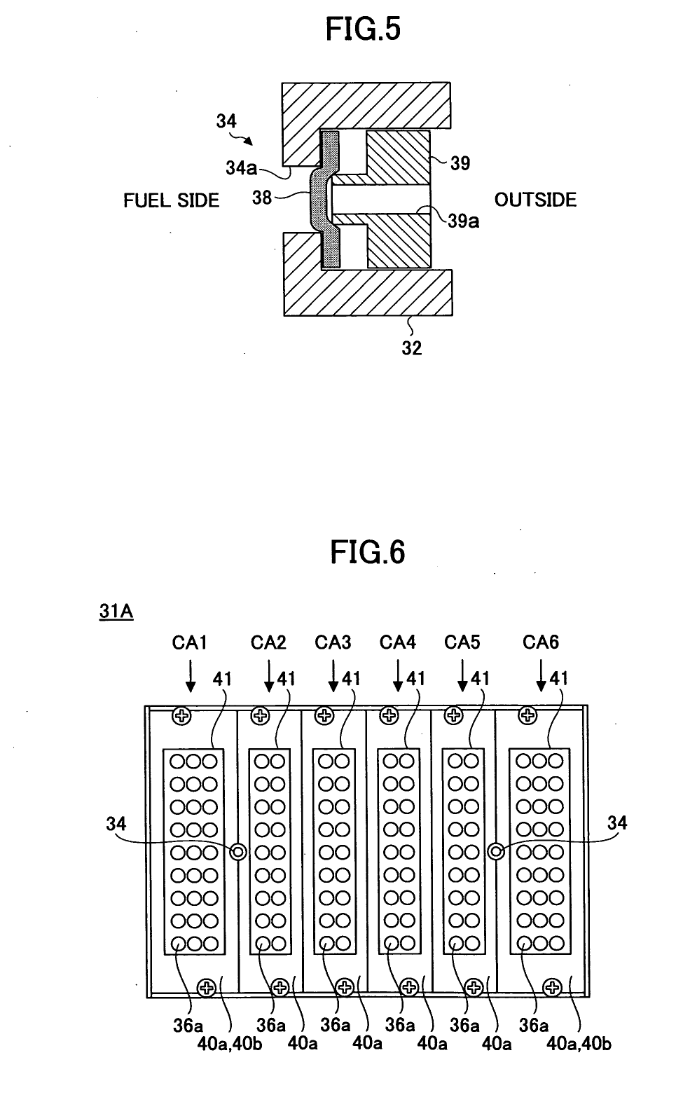

FIG. 5 is an enlarged cross-sectional view of one gas exhaust part 34. As shown in FIG. 5, for example, the gas exhaust part 34 includes a gas permeable film 38 pressed against the portion of an opening 34a formed on the side surface of the fuel supplier 32 as shown in FIG. 4 so that the gas permeable film 38 is brought into contact with the side surface of the fuel supplier 32 from the external gas side towards the fuel side, and a fixing member 39 which presses the gas permeable film 38 and has an opening 39a for gas to flow through from the fuel side to the external gas side.

The gas permeable film 38 is formed from a porous material, and is able to separate a gas and a liquid, specifically, the liquid cannot transmit through the porous material, but only the gas can transmit through the porous material. In other words, the gas staying on the fuel side transmits through to the external gas side, and the methanol water solution acting as the fuel is stopped; hence no leakage happens.

The porous material may be polyethylene, polypropylene, polybutene, poly methyl pentene, or other polyolefins, polytetraethylene, polyvinylidene fluoride, perfluoro alkyl resin, or other fluororesins, polyethylene terephthalate, polybutylene terephthalate, polyethylene naphthalate, and other polyethers, cellulose and derivatives thereof, polystylene, polymethyl methacrylate, polyamide, nylon, polyvinyl chloride, and polycarbonate.

Preferably, the gas permeable film 38 has water repellency. Due to this, it is possible to prevent adhesion of film-like water generated on the air electrode side to the surface of the gas permeable film 38, and prevent degradation of the gas exhaust effect. The water repellency may be exhibited as surface water repellency of the material itself, or may be obtained by inducing reactions between water repellents such as dimethyl dichlorosilane with carboxyl or the like on the surface of the material, or by applying fluororesin or other water repellent materials. In addition, gas exhaust parts having similar structures are also provided in the battery cell structure 31A and the battery cell structure 31B.

Returning to FIG. 4, the gas exhaust parts 34 are provided on side surfaces of the fuel supplier 32, and on the battery cell structure 31A and the battery cell structure 31B, that is, on all surfaces (six) of the fuel supplier 32. With such an arrangement, no matter what posture the fuel battery 20 has, the CO₂ gas generated at the fuel electrode by electricity generation reactions can be exhausted, and this reduces the pressure in the fuel supplier. That is, the space of the fuel supplier containing the CO₂ gas contacts at least one of the six surfaces depending on the posture of the fuel battery 20; hence, with the gas exhaust parts 34 being provided on all six side surfaces, the CO₂ gas can be always exhausted.

It is preferable to provide plural gas exhaust parts 34 on each side surface; further, it is preferable to arrange the gas exhaust parts 34 to be near two ends of the side surface in a longitudinal direction of the side surface. When the fuel battery 20 is vertically or horizontally placed and is tilted slightly from the vertical or horizontal arrangement condition, the space inside the fuel supplier 32 moves to a corner, hence, it is possible to efficiently exhaust the CO₂ gas.

The battery cell structure 31A and the battery cell structure 31B include fuel battery cells CA1 through CA6 and CB1 through CB6, respectively (below, the fuel battery cells are collectively referred to as CA, CB when it is not necessary to identify then individually). The fuel battery cells CA, CB, which have a longitudinal direction in the width direction of the fuel supplier 32 (the X direction), are arranged along a longitudinal direction of the fuel supplier 32 (the Y direction). The fuel electrodes of the fuel battery cells CA, CB are arranged to face the side of the fuel supplier 32, and the air electrodes are arranged to face the external gas side. As described below in detail, each of the fuel battery cells CA, CB includes a cell structure unit having a fuel electrode, a solid electrolyte film, and an air electrode with the cell structure unit being sandwiched by separators 40a and 40b.

On the separators 40a and 40b, there are formed plural ventilation holes 36a on the external gas side, and plural fuel injection holes 36b on the fuel side of the fuel supplier 32. Since the fuel battery 20 is of an air-breathing type, air from the outside diffuses freely through the ventilation holes 36a to supply the air electrode. Additionally, the fuel filling the fuel supplier 32 diffuses freely through the fuel injection holes 36b to supply the fuel electrode.

FIG. 6 is a plan view of the battery cell structure 31A. As shown in FIG. 6, briefly speaking, in the battery cell structure 31A, the separators 40a and 40b are formed on the fuel battery cells CA, and a cell structure unit 41 is sandwiched by the separators 40a and 40b. The ventilation holes 36a formed on the separators 40a and 40b are arranged corresponding to the cell structure unit 41. The total area of the openings of the ventilation holes 36a are 10% through 95% (preferably, 20% through 70%) relative to the area of the cell structure unit 41.

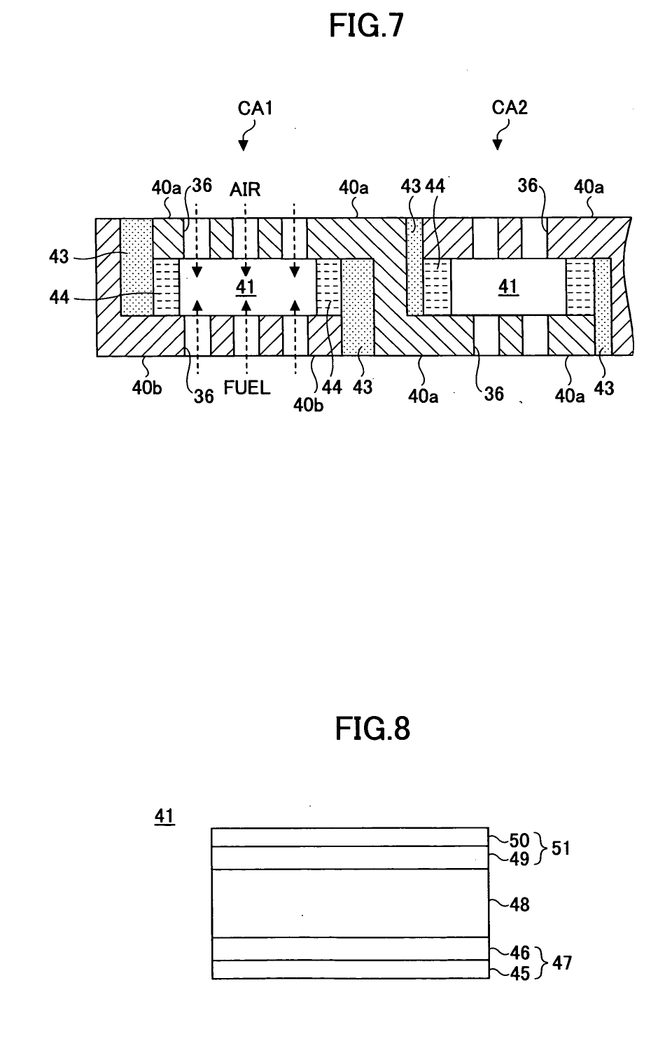

Although not illustrated, the fuel injection holes 36b on the fuel electrode side are also arranged like those on the air electrode side. While maintaining good contact conditions between the fuel and the fuel electrode, a sealing member is provided outside the cell structure unit 41 as shown in FIG. 7 to prevent leakage of the fuel.

FIG. 7 is an enlarged cross-sectional view of the battery cell structure 31A.

FIG. 8 is an enlarged cross-sectional view of the cell structure unit 41.

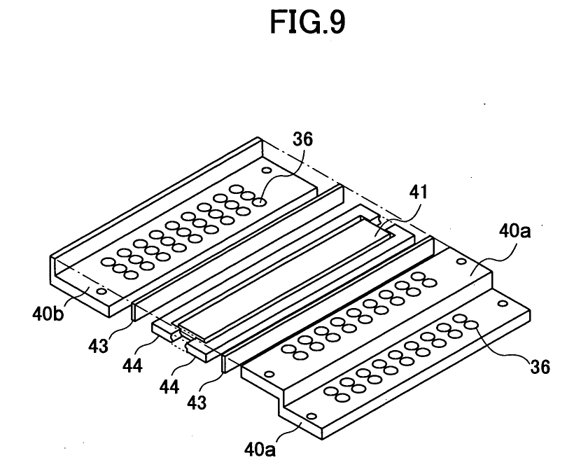

FIG. 9 is an exploded perspective view of the battery cell structure 31A.

As shown in FIG. 7, FIG. 8, and FIG. 9, in the fuel battery cells CA1 and CA2, the cell structure unit 41, a ring-shaped sealing member 43 which encloses the cell structure unit 41, and a plate-like sealing member 44 outside are arranged between two separators 40a and 40b, or 40a and 40a.

The cell structure unit 41 includes a fuel electrode collector 45, a fuel electrode catalyst layer 46 (the stack structure of the fuel electrode collector 45 and the fuel electrode catalyst layer 46 is referred to as a “fuel electrode” 47), a solid electrolyte film 48, an air electrode catalyst layer 49, and an air electrode collector 50 (the stack structure of the air electrode catalyst layer 49 and the air electrode collector 50 is referred to as an “air electrode” 51), with the above components being stacked in the above-mentioned order from the fuel side.

The fuel electrode collector 45 and the air electrode collector 50 may be formed from a mesh of Ni, SUS304, SUS316, or other alloys of high resistance to corrosion. The fuel electrode collector 45 and the air electrode collector 50 may be omitted when the separators 40a, 40b also have the same functions.

The fuel electrode catalyst layer 46 may be formed by applying fine particle catalysts of Pt, or Pt—Pu alloys, carbon powder, and polymers constituting the solid electrolyte film 48 on a porous conductive film such as carbon paper.

The air electrode catalyst layer 49 may be formed from the same materials as the fuel electrode catalyst layer 46.

The solid electrolyte film 48 may be formed from a polymer solid electrolyte film capable of transmitting and transporting protons, for example, a poly perfluorosulfonate resin film, specifically, Nafion (registered trademark) NF117 (product name of Dupont Co.).

In the fuel electrode 47, the following reaction occurs on the catalyst surface of the fuel electrode catalyst layer 46.
CH₃OH+H₂O—>CO₂+6H⁺+6e⁻

The generated protons (H⁺) conduct through the solid electrolyte film 48, and arrive at the air electrode 51. In the air electrode 51, oxygen in air, protons (H⁺), and electrons (e⁻) generated in the adjacent fuel electrode 47 react on the catalyst surface of the air electrode catalyst layer 49 as below,
3/2O₂++6H⁺+6e⁻—>3H₂O

Due to currents of protons and electrons in these reactions, electricity is generated. Further, CO₂ is generated in the fuel electrode 47, and H₂O is generated in the air electrode 51. Here, the methanol water solution is used as the fuel, and the concentration of the methanol water solution is in a range from 5 vol % to 69 vol %. In addition, dimethyl ether (DME), ethanol, and ethylene glycol may be used instead of methanol.

The ring-shaped sealing member 43 and the plate-like sealing member 44 may be formed from materials of high resistance against strong acids, for example, nitrile rubber, fluororubber, or chloroprene rubber. The ring-shaped sealing member 43 may be of a frame-like shape instead of a ring shape, and preferably, the cross section thereof is an ellipse, a circle, or a rectangular. It is preferable that the cross section be an ellipse or a circle because there is no gap occurring between the ring-shaped sealing member 43 and the two separators 40a and 40b when the ring-shaped sealing member 43 is pressed by the two separators 40a and 40b from the top and bottom. The ring-shaped sealing member 43 is arranged to enclose the cell structure unit 41, and as shown in FIG. 7, this prevents leakage of the fuel in the transverse direction, which fuel transmits through the fuel injection holes 36b and immerses the fuel electrode 47.

The plate-like sealing member 44 is arranged outside the ring-shaped sealing member 43 and between the two separators 40a and 40b, or 40a and 40a; this prevents a short circuit between separators, and absorbs a transverse force between the two separators 40a and 40b, or 40a and 40a to improve connection conditions, thus improves the mechanical strength of the battery cell structure 31A and the fuel battery 20.

The separators 40a and 40b may be formed from SUS 316, for example, with a thickness of about 1 mm. On the surface of the separators 40a and 40b, a gold plating film may be formed because it is able to reduce the contact resistance, and is of good wetting characteristics. In the fuel battery cells CA1 and CA6 on the two ends of the battery cell structure 31A, the separator 40b is of an L-shaped cross section. As shown in FIG. 7, in the adjacent fuel battery cells CA1 and CA2, the separator 40a having nearly a Z-shape is in contact with the air electrode 51 of the fuel battery cell CA1 and the fuel electrode 47 of the fuel battery cell CA2 for electrical connection of them. Since the separator 40a has a large size in the current-flowing direction, the cross section thereof is large, and this reduces the connection resistance, and reduces the voltage drop between the air electrode 51 and the fuel electrode 47.

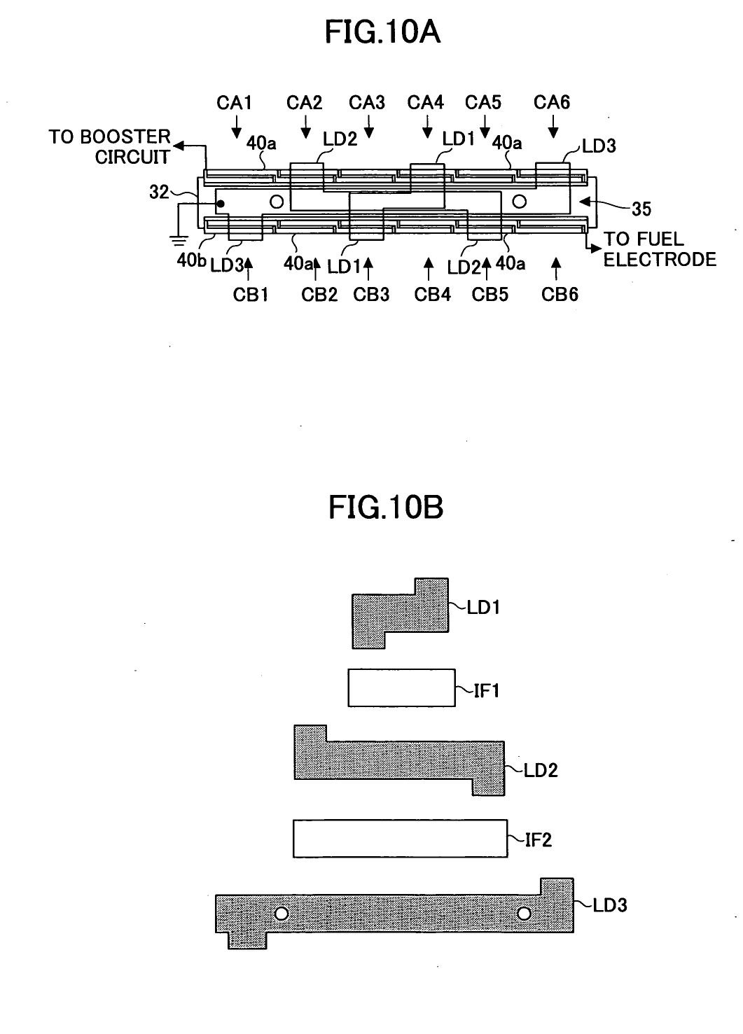

FIG. 10A is a side view for illustrating a connection condition of the fuel battery cells CA and CB.

FIG. 10B is an exploded side view of leads for connecting the fuel battery cells CA and CB.

As shown in FIG. 10A, in the fuel battery cells CA constituting the battery cell structure 31A, the air electrode of the fuel battery cell CA1 serves as an output side, and the fuel battery cells CA1 through CA6 are electrically connected with each other in order of the fuel electrode of CA1/the air electrode of CA1—the fuel electrode of CA2/the air electrode of CA2—the fuel electrode of CA3/the air electrode of CA3 . . . the fuel electrode of CA5/the air electrode of CA5—the fuel electrode of CA6/the air electrode of CA6. Namely, the fuel battery cells CA1 through CA6 are electrically connected in series in order of the arrangement of them. Here, the symbol “—” indicates connection by the above-mentioned separator 40a having nearly a Z-shape, and the symbol “/” indicates a cell structure unit.

On the other hand, in the battery cell structure 31B opposite to the battery cell structure 31A, the fuel electrode of the fuel battery cell CB6 serves as the output side, and the fuel battery cells CB1 through CB6 are electrically connected in order of the fuel electrode of CB6/the air electrode of CB6—the fuel electrode of CB5/the air electrode of CB5—the fuel electrode of CB4/ . . . /the air electrode of CB2—the fuel electrode of CB1/the air electrode of CB1. Namely, the fuel battery cells CB1 through CB6 are electrically connected in series in order opposite to the arrangement order of the fuel battery cells CB1 through CB6.

That is to say, in the battery cell structure 31A, the direction of serial connection of the fuel battery cells CA1 through CA6 is from the fuel electrode of CA1 to the air electrode of CA6, and in the battery cell structure 31B, the direction of serial connection of the fuel battery cells CB1 through CB6 from the fuel electrode of CB6 to the air electrode of CB1, which directions are opposite to each other.

Further, the fuel battery cells CA in the battery cell structure 31A are connected with the fuel battery cells CB in the battery cell structure 31B are connected in the following way. That is, the fuel battery cells which are opposite to each other on a diagonal line are connected in parallel. Specifically, CA1 and CB6, CA2 and CB5, CA3 and CB4, CA4 and CB3, CA5 and CB2, CA6 and CB1, each pair of which are opposite to each other on a diagonal line, are electrically connected with the air electrodes thereof in common.

In detail, as shown in FIG. 10A, a cell connector 35 is provided on a side surface of the fuel supplier 32, CA2 and CB5 are connected with a lead LD2, CA4 and CB3 are connected with a lead LD1, and CA6 and CB1 are connected with a lead LD3 all on the air electrode side. In addition, although not illustrated, another cell connector 35 is provided on the other side surface of the fuel supplier 32, and CA1 and CB6, CA3 and CB4, and CA6 and CB1 are electrically connected in the same way with leads all on the air electrode side.

As shown in the exploded side view in FIG. 10B, the cell connector 35 includes leads LD1 through LD3, which have hinges on two ends thereof for connecting to the air electrode side of the separators 40a and 40b, and are stacked with insulating films IF 1 and IF2, such as polyimide films or the like, in between for electrical insulation.

For example, the leads LD1 through LD3 are formed from SUS304, SUS316 having a width of 3 to 10 mm, and a thickness of 100 μm. It is preferable that the leads LD1 through LD3 are thick in order to reduce the voltage drop.

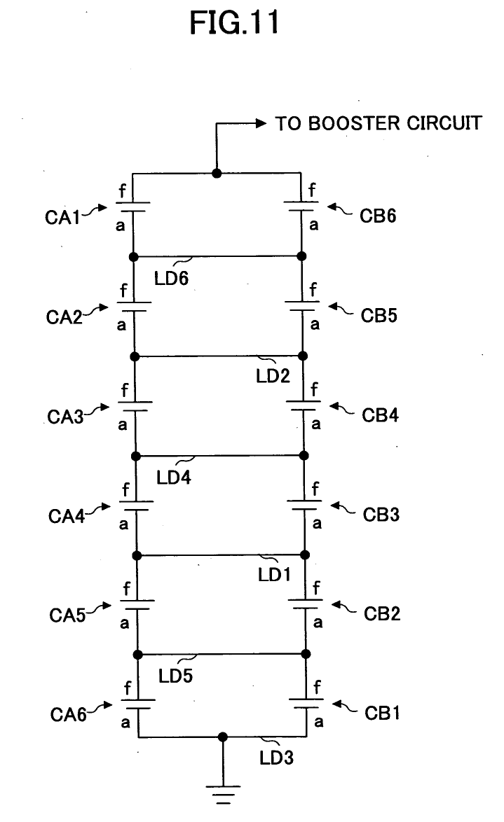

FIG. 11 a circuit diagram illustrating an equivalent circuit of the fuel battery 20, where the fuel electrode is indicated by “f”, and the air electrode is indicated by “a”.

Referring to FIG. 11, as described in FIG. 10, with leads LD1 through LD3, three groups of the fuel battery cells CA2-CB5, CA4-CB3, and CA6-CB1 are electrically connected at their air electrodes, and with not-illustrated leads LD4 through LD6, the other three groups of the fuel battery cells CA1-CB6, CA3-CB4, and CA5-CB2 are electrically connected at their air electrodes. By connection in this manner, the fuel battery cells opposite to each other on a diagonal line are connected in parallel.

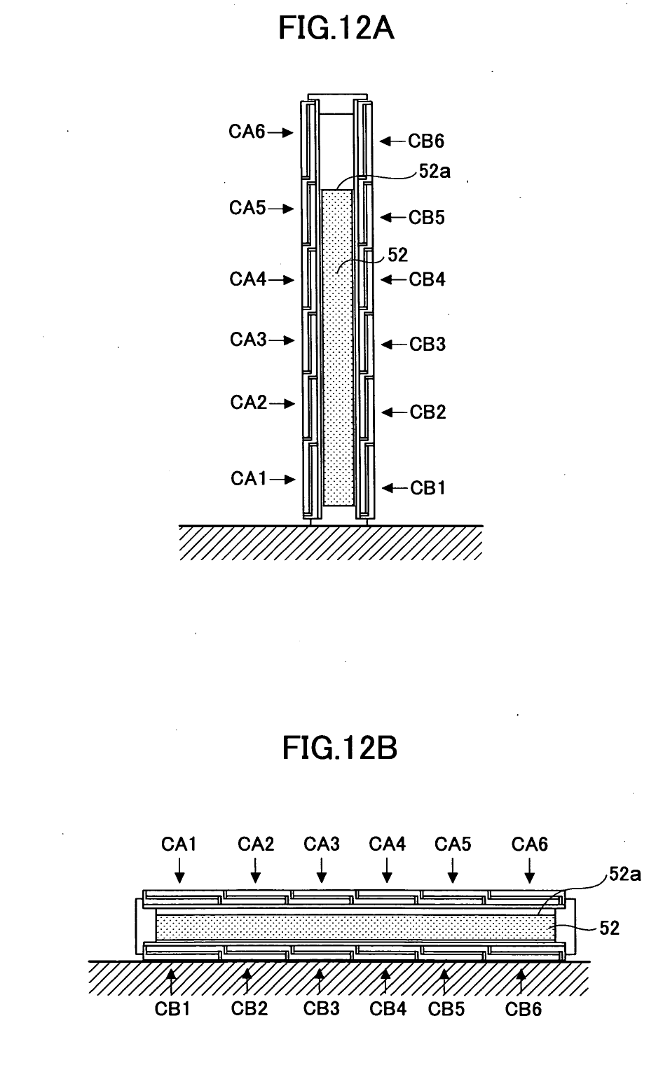

FIG. 12A and FIG. 12B are views illustrating the relation between the posture of the fuel battery 20 and the surface of the liquid fuel in the fuel supplier 32.

As shown in FIG. 12A, when the fuel battery 20 is installed in an upright condition, the surface of the liquid fuel becomes lower than the positions of the fuel battery cells CA6 and CB6, and the fuel 52 cannot be supplied to the fuel electrodes of the fuel battery cells CA6 and CB6, hence, the fuel battery cells CA6 and CB6 cannot generate electricity. In this case, referring to FIG. 11, because CA6 is connected with CB1 in parallel, and CB6 is connected with CA1 in parallel, the fuel battery cells CB1 and CA1 can generate electricity, the fuel battery 20 as a whole can generate an output voltage, and supply power to the outside.

It is easy to understand that if the fuel battery cells CA6 and CB6 of the fuel battery 20 are at the bottom, similarly, the fuel battery 20 as a whole can generate an output voltage.

On the other hand, in an example for comparison, to which the present invention is not applied, in the fuel battery, if the fuel cannot be supplied to the fuel electrodes of the fuel battery cells CA6 and CB6, the fuel battery cells CA6 and CB6 cannot generate electricity, and the current is intercepted in CA6 and CB6. Consequently, the output voltage becomes zero.

As shown in FIG. 12B, when the fuel battery 20 is installed in a horizontal condition, the surface 52a of the liquid fuel is lower than the positions of the fuel battery cells CA1 through CA6, and the fuel 52 cannot be supplied to the fuel electrodes of the fuel battery cells CA1 and CA6. However, even when the output voltage of the fuel battery cells CA1 and CA6 is zero, the fuel battery cells CB1 and CB6 can normally generate electricity, thus the fuel battery 20 as a whole can supply power.

In addition, when the fuel battery 20 is rotated from the upright state in FIG. 12A to the horizontal state in FIG. 12B, the fuel 52 cannot be supplied to portions of the fuel battery cells CA5 or CB5 temporarily. Even in this case, similar to FIG. 12A, the fuel battery cells CB2 and CA2, which are connected with the fuel battery cells CA5 or CB5 in parallel, can still generate electricity normally, thus, lowering of the output voltage is preventable.

Other examples are presented to show the advantages of the present invention.

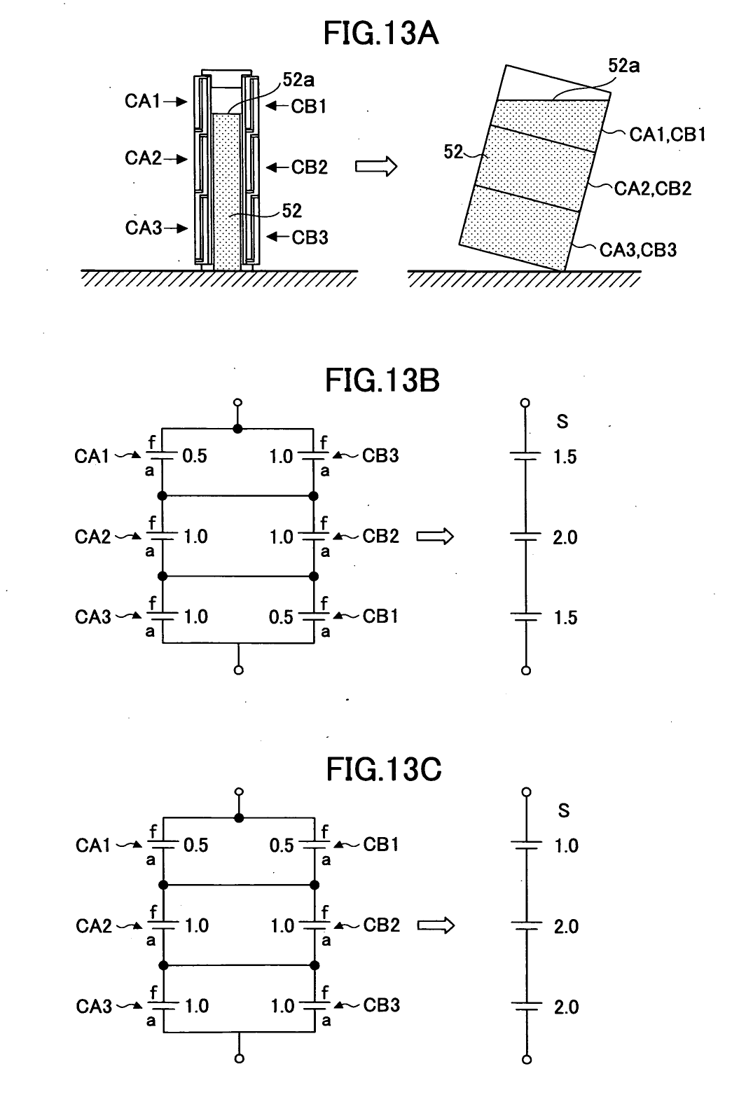

FIG. 13A is a schematic view illustrating the fuel battery of the present embodiment.

FIG. 13B is a circuit diagram illustrating an equivalent circuit of the fuel battery in FIG. 13A.

FIG. 13C is a circuit diagram illustrating an equivalent circuit of the fuel battery to which the present invention is not applied.

FIG. 13A shows a fuel battery in which two sets of three fuel battery cells are arranged on two surfaces of the fuel battery, respectively. Specifically, fuel battery cells CA1 to CA3 are arranged in order on one side of the fuel battery, and fuel battery cells CB1 to CB3 are arranged on the other side of the fuel battery in the same order as the fuel battery cells CA1 to CA3. As shown on the right side in FIG. 13A, assume the fuel battery is tilted slightly, the surface 52a of the liquid fuel 52 crosses the fuel electrodes of the fuel battery cells CA1 and CB1, and the fuel 52 can be supplied to only 50% of the areas of the fuel electrodes of the fuel battery cells CA1 and CB1.

Referring to FIG. 13B, in the fuel battery 60 of the present example, along the direction from CA1 to CA3, and along the direction from CB3 to CB1, the fuel electrodes are electrically connected to the air electrodes in series, and CA1 and CB3, CA2 and CB2, and CA3 and CB1 are electrically connected in parallel, respectively. The working areas of the fuel battery cells for electricity generation are indicated (on the right side of FIG. 13B) with the working areas of one set of fuel battery cells and the working areas of the fuel battery cells connected in parallel being summed. Here, it is assumed that a figure “1” represents that the fuel can be supplied to 100% of the area of the fuel electrode of one fuel battery cell, a figure “0.5” represents that the fuel can be supplied to 50% of the area of the fuel electrode of one fuel battery cell.

Referring to FIG. 13C, showing a fuel battery 100 to which the present invention is not applied, in the fuel battery 100, along the direction from CA1 to CA3, and along the direction from CB1 to CB3, the fuel electrodes are electrically connected to the air electrodes in series, and CA1 and CB1, CA2 and CB2, and CA3 and CB3 are electrically connected in parallel, respectively. In the same way, the working areas of the fuel battery cells for electricity generation are indicated (on the right side of FIG. 13C).

As described above, assuming the fuel 52 can be supplied to only 50% of the areas of the fuel electrodes of the fuel battery cells CA1 and CB1, the output voltages during constant current discharging of the fuel battery of the present example is compared to that of the example for comparison.

Assume the fuel battery cell has an output voltage V, an open voltage V0 (when the output end is open), and a current density J (for example, in units of A/cm²), then, the output voltage V when a current is flowing is expressed as below.
V=V0+a×J (1)

where a is a negative constant, which shows a varying rate of the output voltage V relative to the current density J. In addition, the following equation is satisfied.
J=I/S (2)

where I represents the output current of the fuel battery. Because the output current I is constant, from equation (2), the current density J is inversely proportional to an area S of the fuel electrode immersed in the fuel of the fuel battery cell.

Thus, for a fuel battery cell with S equaling 2.0, which is the area of the fuel electrode immersed in the fuel of the fuel battery cell, if the current density J is 1.0, then, when S=1.5, one has J=1.33, and when S=1.0, one has J=2.0. Utilizing the relationship between S and J, and the relation expressed by equation (1), the output voltages V in the example of the present invention as shown in FIG. 13B and in the example for comparison as shown in FIG. 13C can be found as below.

In the example of the present invention,
V=3V0+3.66a

In the example for comparison,
V=3V0+4.0a

As mentioned above, since a is a negative number, during constant current discharging, the output voltages V in the example of the present invention is higher than that in the example for comparison, it reveals that the connection method of the present invention is advantageous over the example for comparison.

If using the actual relationship between the output voltage and the current density, when V0=1.5 V, and a=−0.5, in the example of the present invention, the output voltage is 2.67 V, and in the example for comparison, the output voltage is 2.50 V, the output voltage in the example of the present invention is higher than that in the example for comparison by 7%, implying the example of the present invention is superior because the output voltage is high even with the same amount of fuel.

Next, modifications of the present embodiment are described by modifying the connection in the fuel battery shown in FIG. 11.

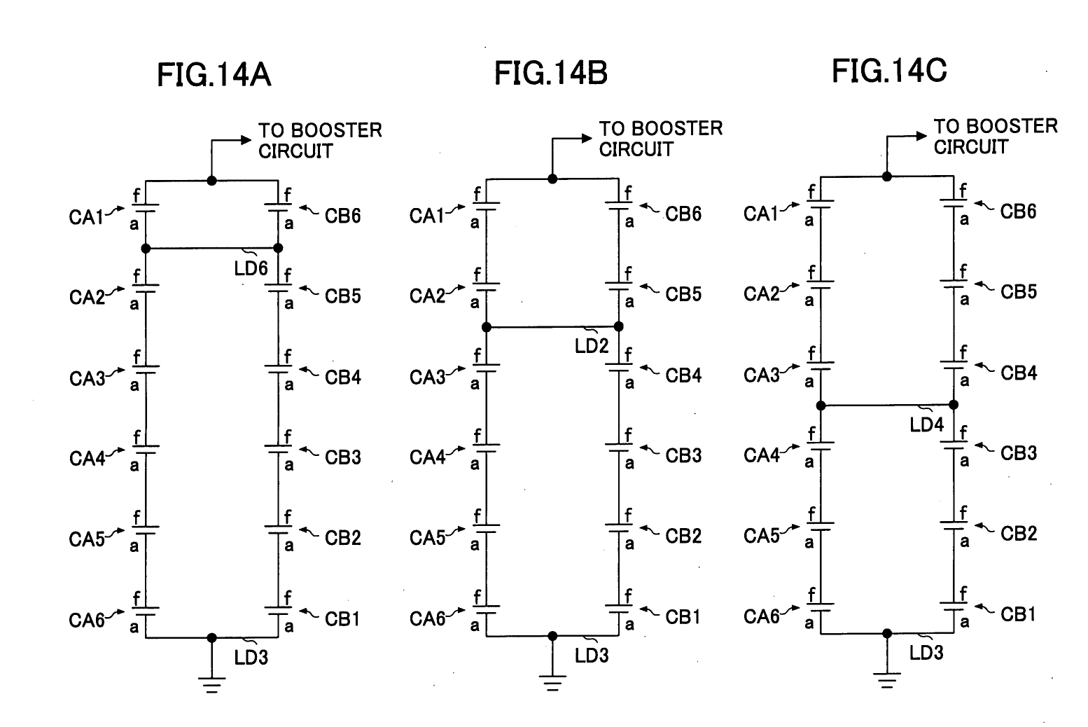

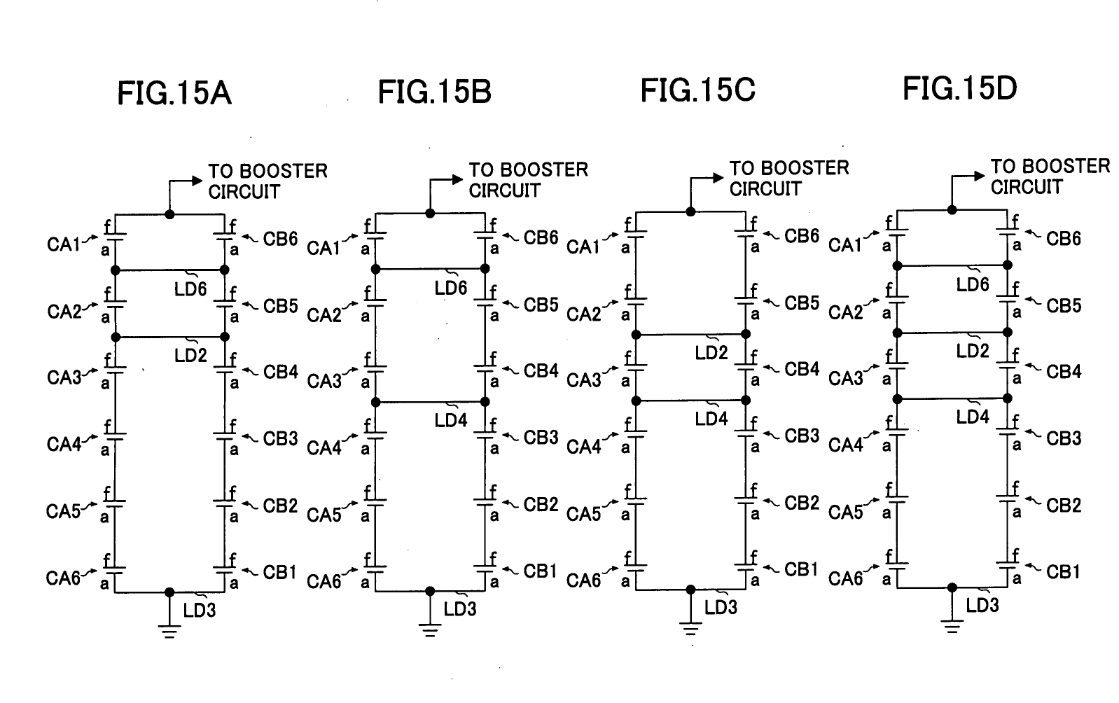

FIG. 14A through FIG. 14C and FIG. 15A through FIG. 15D are circuit diagrams illustrating equivalent circuits of the fuel batteries as modifications of the first embodiment. In FIG. 14A through FIG. 14C and FIG. 15A through FIG. 15D, the same reference numbers are assigned to the corresponding elements as those illustrated in FIG. 11, and overlapping descriptions are omitted.

Referring to FIG. 14A through FIG. 14C, in the fuel batteries, the connector between the fuel battery cells CA1 through CA6 and the connector between the fuel battery cells CB1 through CB6 are electrically connected at one point. In FIG. 14A, the connector between the fuel battery cells CA1 and CA2 is electrically connected with the connector between the fuel battery cells CB6 and CB5 through the lead LD6. In FIG. 14B, the connector between the fuel battery cells CA2 and CA3 is electrically connected with the connector between the fuel battery cells CB5 and CB4 through the lead LD2. In FIG. 14C, the connector between the fuel battery cells CA3 and CA4 is electrically connected with the connector between the fuel battery cells CB4 and CB3 through the lead LD4.

Specifically, with FIG. 14B as an example, in FIG. 14B, among the fuel battery cells arranged to sandwich the fuel supplier 32, the air electrode of the fuel battery cell CA2 (precisely speaking, the separator 40a of the air electrode) and the air electrode (precisely speaking, the separator 40a of the air electrode) of the fuel battery cell CB5 are connected with the lead LD2, and the lead LD1 as shown in FIG. 10 (and leads LD4 through LD6 not illustrated in FIG. 10) is not provided.

For example, considering the situation in which the fuel battery is in the upright state as shown in FIG. 12A, and the surface of the liquid fuel is lower than the positions of the fuel battery cells CA6 and CB6, since the fuel 52 cannot be supplied to the fuel electrodes of the fuel battery cells CA6 and CB6, the fuel battery cells CA6 and CB6 cannot generate electricity. However, even under the above mentioned condition, in the fuel batteries connected as shown in one of FIG. 14A through FIG. 14C, due to the fuel battery cells able to generate electricity, the output side and the grounding side are electrically connected, hence power supply of the fuel batteries does not stop. It is the same when considering the situation in which the fuel battery is in the horizontal state as shown in FIG. 12B.

Further, in addition to the connection conditions shown in FIG. 14A through FIG. 14C, when the connector between the fuel battery cells CA4 and CA5 is electrically connected with the connector between the fuel battery cells CB2 and CB3, or the connector between the fuel battery cells CA5 and CA6 is electrically connected with the connector between the fuel battery cells CB1 and CB2, similarly, power supply of the fuel batteries does not stop.

In this way, when the connector between the m-th fuel battery cell and the (m+1)-th fuel battery cell along the direction from the fuel battery cell CA1 to the fuel battery cell CA6 is electrically connected at only one point with the connector between the m-th fuel battery cell and the (m+1)-th fuel battery cell along the direction from the fuel battery cell CB6 to the fuel battery cell CB1, even if the surface of the liquid fuel changes, and some fuel battery cells cannot generate electricity, the counterpart fuel battery cells connected in parallel can generate electricity, and thus, the fuel battery does not stop power supply, and it is possible to prevent lowering of the power supply.

Referring to FIG. 15A through FIG. 15D, in the fuel batteries, even when connectors between adjacent fuel battery cells CA1 through CA6 and connectors between adjacent fuel battery cells CB1 through CB6 are electrically connected at two or three points, even when the surface of the liquid fuel changes, power supply of the fuel batteries does not stop.

In this way, when the connection points increase, since the number of the fuel battery cells contributing to power supply increases, the fuel utilization improves compared to the method of connection at one point as shown in FIG. 14A through FIG. 14C. Particularly, it is preferable that all connectors between adjacent fuel battery cells CA1 through CA6 and all connectors between adjacent fuel battery cells CB1 through CB6 are electrically connected, as shown in FIG. 11.

In addition, the connection points are not limited to those shown in FIG. 15A through FIG. 15D; in each of FIG. 15A through FIG. 15D, the connection positions may be symmetric, and the same effects can be obtained.

Below, an example of fabricating the above mentioned fuel battery is described.

### EXAMPLE

In this example, the fuel battery of a structure same as that shown in FIG. 4 and FIG. 8 is fabricated, assuming six fuel battery cells are arranged on each surfaces of the fuel battery, and the area of one cell structure unit in one fuel battery cell is 3 cm². The connection conditions between the fuel battery cells are the same as the equivalent circuit in FIG. 11.

The cell structure unit is formed from the following materials.

The fuel electrode catalyst layer: Pt—Ru alloy-carried catalyst TEC61E54 (manufactured by Tanaka Kikinzoku Co.),

The air electrode catalyst layer: platinum carried catalyst TEC10E50E (manufactured by Tanaka Kikinzoku Co.),

The solid electrolyte film: solid electrolyte Nafion (registered trademark) NF117 (product name of Dupont Co.),

Fuel: a 10 vol % methanol water solution,

A fuel cartridge supplies the 10 vol % methanol water solution to fill the fuel supplier, and 95% of the total area of the fuel electrodes is supplied with the fuel when the fuel battery is installed in the upright condition as shown in FIG. 12A. The output power is evaluated with the fuel battery being in the upright condition as shown in FIG. 12A, in the horizontal condition as shown in FIG. 12B, and in the tilted condition, respectively.

It is found that the output power is 0.72 W when the fuel battery is in the upright condition, 0.36 W in the horizontal condition, and from 0.36 W to 0.72 W in the tilted condition, and the output power is not zero under any conditions. Hence, it is possible to prevent stoppage of power supply, obtaining a fuel battery of high reliability.

### Second Embodiment

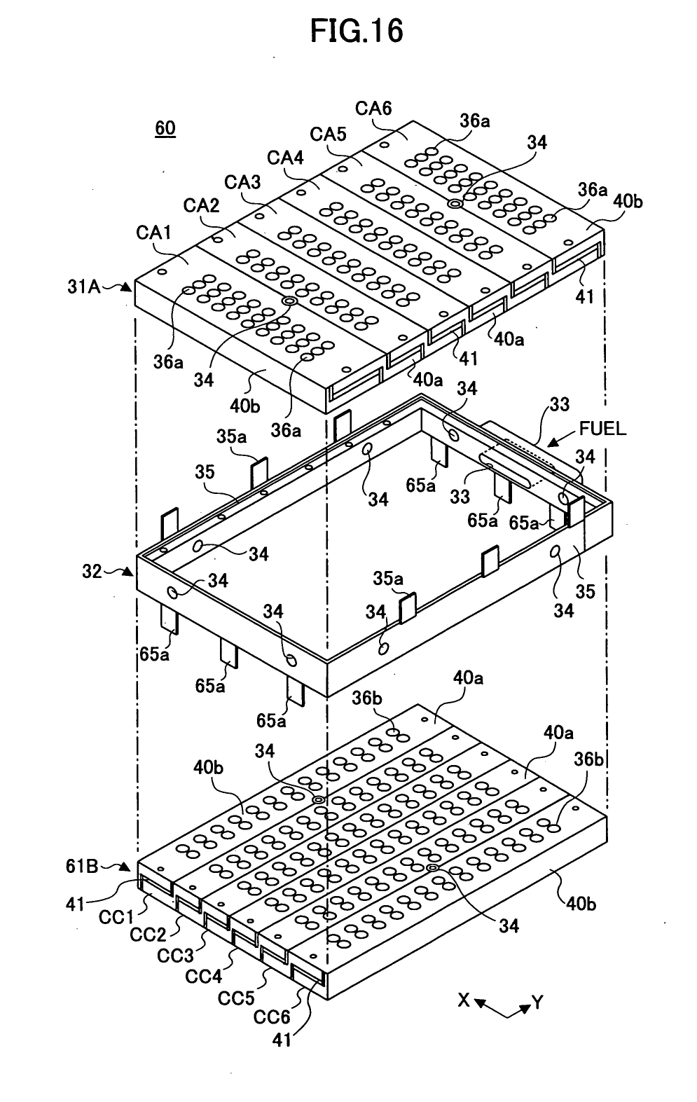

FIG. 16 is an exploded perspective view of a fuel battery 60 according to a second embodiment of the present invention.

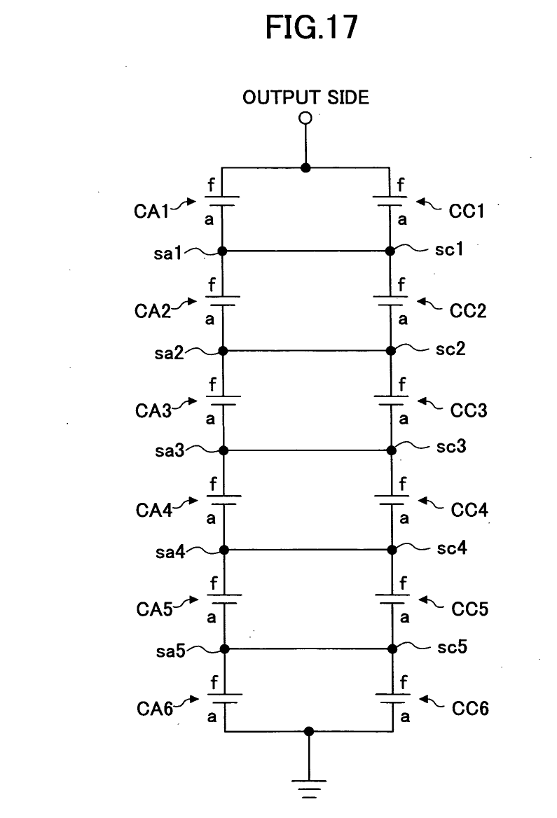

FIG. 17 is a circuit diagram illustrating an equivalent circuit of the fuel battery 60.

In FIG. 16 and FIG. 17, the same reference numbers are assigned to the corresponding elements as those illustrated previously, and overlapping descriptions are omitted.

As shown in FIG. 16 and FIG. 17, briefly speaking, the fuel battery 60 includes the fuel supplier 32, and the battery cell structure 31A and a battery cell structure 61B which are arranged to face each other respectively to sandwich the fuel supplier 32, and in the battery cell structure 31A, fuel battery cells CA1 through CA6 are arranged, and in the battery cell structure 61B, fuel battery cells CC1 through CC6 are arranged. In the fuel battery 60, the arrangement direction (the X direction) of the fuel battery cells CC1 through CC6 in the battery cell structure 61B is perpendicular to the arrangement direction (the Y direction) of the fuel battery cells CA1 through CA6 in the battery cell structure 31A. The fuel battery 60 is nearly the same as the fuel battery 20 of the first embodiment except that the conditions of the parallel connection between the fuel battery cells CA1 through CA6 and the fuel battery cells CC1 through CC6 are different. In addition, the fuel battery cells CC1 through CC6 have the same structure as the fuel battery cells CB1 through CB6 except that the arrangement directions thereof are different.

In the battery cell structure 31A and the battery cell structure 61B, the fuel battery cells CA1 through CA6 and the fuel battery cells CC1 through CC6 are electrically connected in series in order of the arrangement direction. Specifically, in the battery cell structure 31A, the fuel electrode of the fuel battery cell CA1 serves as an output side, and the fuel battery cells CA1 through CA6 are electrically connected with each other in order of the fuel electrode of CA1/the air electrode of CA1—the fuel electrode of CA2/the air electrode of CA2—the fuel electrode of CA3/ . . . /the air electrode of CA5—the fuel electrode of CA6/the air electrode of CA6. Namely, the fuel battery cells CA1 through CA6 are electrically connected in series in order of the arrangement direction of them.

Here, the symbol “—” indicates the connection by the above-mentioned separator 40a having nearly a Z-shape, and the symbol “/” indicates one cell structure unit 41.

On the other hand, in the battery cell structure 61B facing the battery cell structure 31A, the fuel electrode of the fuel battery cell CC1 serves as an output side, and the fuel battery cells CC1 through CC6 are electrically connected with each other in order of the fuel electrode of CC1/the air electrode of CC1—the fuel electrode of CC2/the air electrode of CC2—the fuel electrode of CC3/ . . . /the air electrode of CC5—the fuel electrode of CC6/the air electrode of CC6. Namely, the fuel battery cells CC1 through CC6 are electrically connected in series in order of the arrangement direction of them.

Further, the fuel battery cells CA1 through CA6 are connected with the fuel battery cells CC1 through CC6 in parallel in the following way. As shown in FIG. 17, CA1 and CC1, CA2 and CC2, CA3 and CC3, CA4 and CC4, CA5 and CC5, and CA6 and CC6 are electrically connected in parallel respectively. Namely, in the battery cell structure 31A and the battery cell structure 61B, connectors sa1 through sa5 and connectors sc1 through sc5 are connected respectively with their m-th ((m is an integer in the range from 1 to 5) connectors sam and scm from the output side being connected with each other.

With the fuel battery cells being connected in this way, for example, even when the fuel is reduced up to one-third of the area of one fuel electrode, for example when the fuel battery 60 in FIG. 16 is installed upright with the battery cell structure 61B and the battery cell structure 31A being vertically arranged with the fuel battery cells CA6 on the top, in addition to the fuel battery cells CA1 and CA2, the fuel electrodes of the fuel battery cells CC1 through CC6 are also in contact with the fuel. Meanwhile, when the fuel battery 60 in FIG. 16 is installed upright with the battery cell structure 61B and the battery cell structure 31A being vertically arranged with the fuel battery cells CC6 on the top, in addition to the fuel battery cells CC1 and CC2, the fuel electrodes of the fuel battery cells CA1 through CA6 are also in contact with the fuel. Since one of the fuel battery cells connected in parallel is always in contact with the fuel, the fuel battery 60, which includes the parallel connected fuel battery cells CC1 through CC6 and the fuel battery cells CA1 through CA6 with each of the fuel battery cells CC1 through CC6 and the fuel battery cells CA1 through CA6 being connected in series, can always supply power. Thus, even when the surface of the liquid fuel filling in the fuel supplier changes due to the posture of the fuel battery, one of the fuel battery cells connected in parallel is always in contact with the fuel, and the fuel battery 60 can always supply power.

Therefore, since the fuel battery 60 includes the parallel-connected fuel battery cells CC1 through CC6 and the fuel battery cells CA1 through CA6 with each of the fuel battery cells CC1 through CC6 and the fuel battery cells CA1 through CA6 being connected in series, it is possible to avoid stoppage of supply power even when the posture of the fuel battery changes.

The fuel battery cells CA1 through CA6 and the fuel battery cells CC1 through CC6 constituting the battery cell structure 31A and the battery cell structure 61B, respectively, and the fuel supplier 32 are the same as those described in the first embodiment, hence, detailed descriptions are omitted.

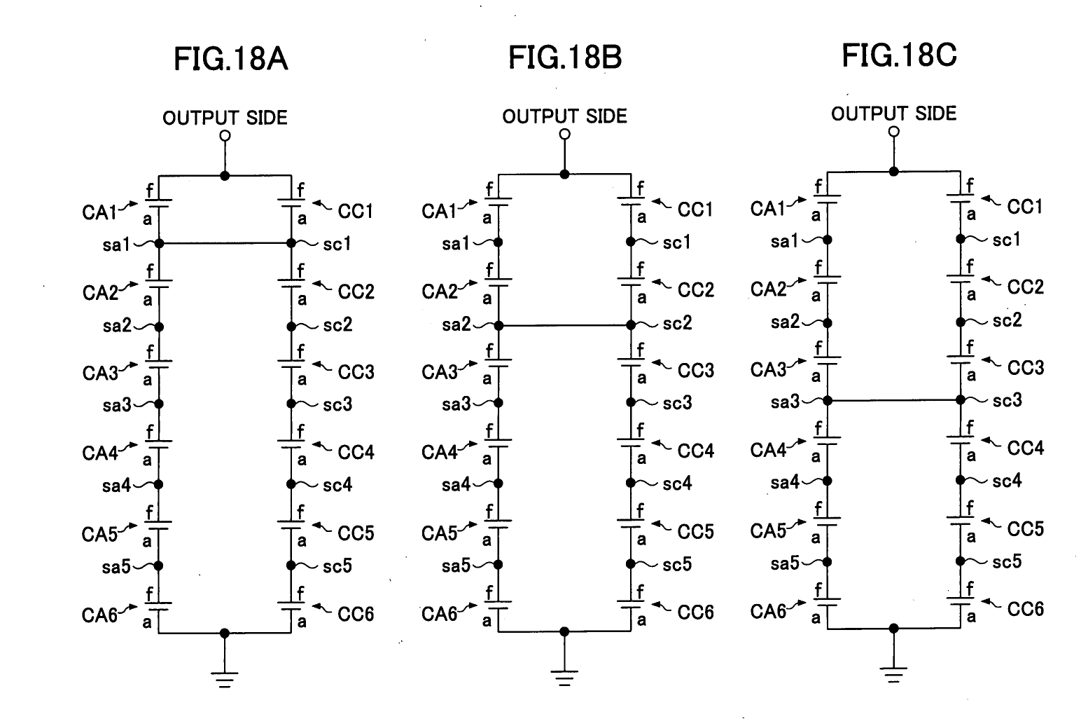

FIG. 18A through FIG. 18C are circuit diagrams illustrating equivalent circuits of the fuel batteries as a first modification of the second embodiment.

As shown in FIG. 18A through FIG. 18C, in the fuel batteries, the connectors sa1 through sa5 between adjacent fuel battery cells among the fuel battery cells CA1 through CA6 and the connectors sc1 through sc5 between adjacent fuel battery cells among the fuel battery cells CC1 through CC6 are electrically connected at only one point. In FIG. 18A, the connector sa1 between the fuel battery cells CA1 and CA2 is electrically connected with the connector sc1 between the fuel battery cells CC1 and CC2. In FIG. 18B, the connector sa2 between the fuel battery cells CA2 and CA3 is electrically connected with the connector sc2 between the fuel battery cells CC2 and CC3. In FIG. 18C, the connector sa3 between the fuel battery cells CA3 and CA4 is electrically connected with the connector sc3 between the fuel battery cells CC3 and CC4. In other words, the m-th connectors sam, scm (m is an integer in the range from 1 to 5) from the output side of the battery cell structure 31A and the battery cell structure 61B, respectively, are connected with each other at only one point.

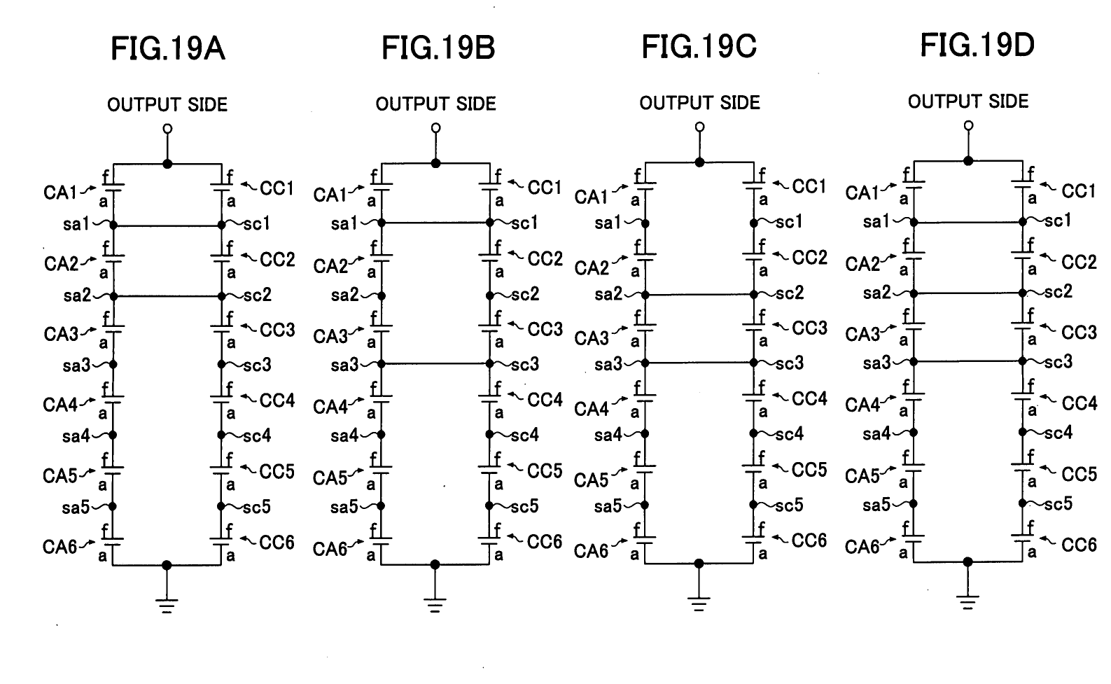

FIG. 19A through FIG. 19D are circuit diagrams illustrating equivalent circuits of the fuel batteries as a second modification of the second embodiment.

As shown in FIG. 19A through FIG. 19D, in the fuel batteries, the connectors sa1 through sa5 between adjacent fuel battery cells among the fuel battery cells CA1 through CA6 and the connectors sc1 through sc5 between adjacent fuel battery cells among the fuel battery cells CC1 through CC6 are electrically connected at two or three points. Specifically, the m-th connectors sam, scm (m is an integer in the range from 1 to 5) from the output side of the battery cell structure 31A and the battery cell structure 61B, respectively, are connected with each other at two or three points.

As shown by the first modification in FIG. 18A through FIG. 18C, and by the second modification in FIG. 19A through FIG. 19D, by parallel connections of the fuel battery cells, the same advantages of the present embodiment are obtainable. That is, it is possible to avoid stoppage of supply power even when the surface of the liquid fuel filling in the fuel supplier changes due to the posture of the fuel battery.

It should be noted that although it is exemplified that each of the battery cell structure 31A and the battery cell structure 61B includes six fuel battery cells, but the number of the fuel battery cells may be 2, 3, 4, 5, 7 or more, and the same advantages of the present embodiment, the first modification, and the second modification are obtainable.

In addition, it is preferable that each of the battery cell structure 31A and the battery cell structure 61B is of a square shape. Due to this, it is possible to more reliably prevent stoppage of power supply, and reduce the change of the output voltage of the fuel battery.

Next, an example of the relationship between the posture of the fuel battery and the output voltage of the fuel battery according to the present embodiment is explained. For purpose of comparison, an example according to the first embodiment, and an example to which the present invention is not applied are also presented.

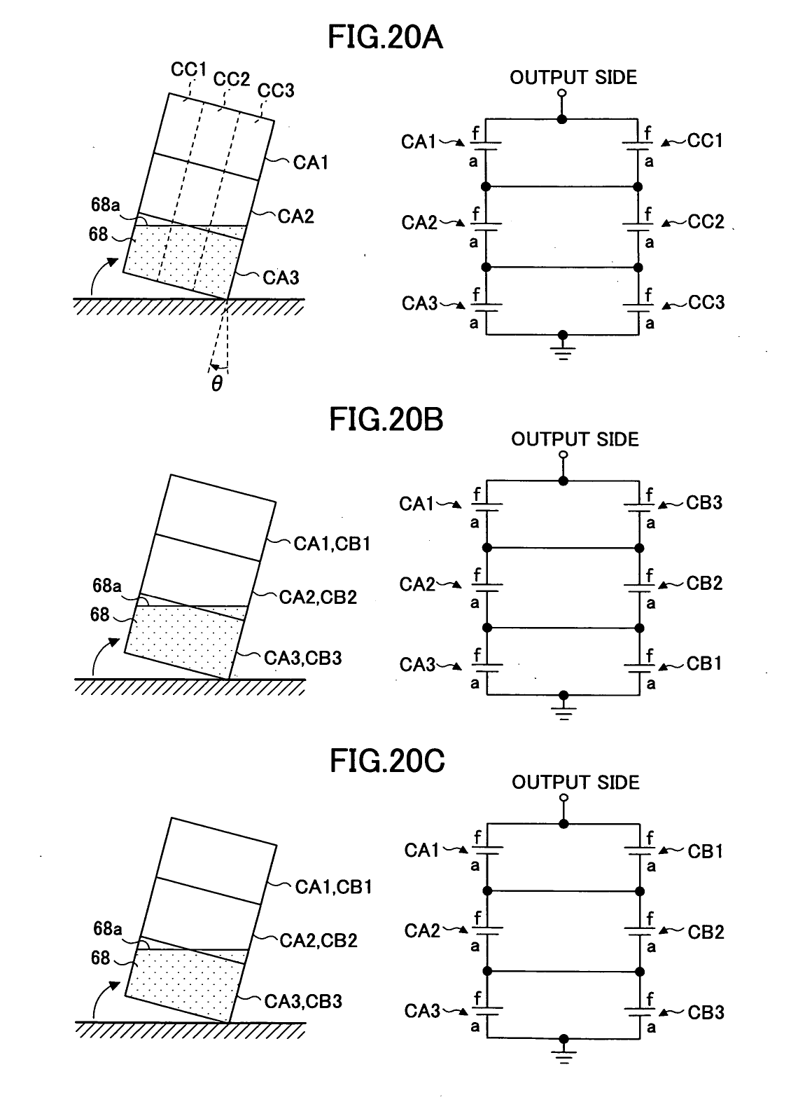

FIG. 20A includes a schematic view illustrating the fuel battery of the second embodiment and a circuit diagram of the equivalent circuit of the fuel battery (example 1).

FIG. 20B includes a schematic view illustrating the fuel battery of the first embodiment and a circuit diagram of the equivalent circuit of the fuel battery (example 2).

FIG. 20C includes a schematic view illustrating a fuel battery to which the present invention is not applied (as an example for comparison) and a circuit diagram of the equivalent circuit of the fuel battery (example for comparison 1).

In the fuel batteries of the examples 1 and 2, and in the example for comparison 1, three fuel battery cells CA1 through CA3, or CB1 through CB3, or CC1 through CC3 are arranged on one side of the fuel batteries, and on the right side of FIG. 20A through FIG. 20C, the equivalent circuits of the fuel batteries are presented respectively are presented for illustrating the electrical connection relationship.

Referring to FIG. 20A, in the first example of the fuel battery according to the second embodiment, the fuel battery cells CA1 through CA3 are arranged in order from the top to the bottom on one side of the fuel supplier (not illustrated), and on the other side of the fuel supplier, the fuel battery cells CC1 through CC3 are arranged to be perpendicular to the arrangement direction of the fuel battery cells CA1 through CA3. In addition, in the first example of the fuel battery, the fuel battery cells CA1 through CA3 and the fuel battery cells CC1 through CC3 are connected in series in order from CC1 to CC3, and CA1 and CC1, CA2 and CC2, CA3 and CC3 are electrically connected in parallel.

Referring to FIG. 20B, in the second example of the fuel battery according to the first embodiment, the fuel battery cells CA1 through CA3 are arranged in order from the top to the bottom on one side of the fuel supplier (not illustrated), and on the other side of the fuel supplier, the fuel battery cells CB1 through CB3 are arranged in order in the same direction of the fuel battery cells CA1 through CA3. In addition, in the second example of the fuel battery, the fuel battery cells CA1 through CA3 and the fuel battery cells CB1 through CB3 are connected in series with the fuel battery cells CA1 through CA3 being in order of CA1 to CA3, and the fuel battery cells CB1 through CB3 being in opposite order, that is, in order of CB3 to CB1. In addition, CA1 and CB3, CA2 and CB2, CA3 and CB1 are electrically connected in parallel.

Referring to FIG. 20C, in the example for comparison 1, the fuel battery cells CA1 through CA3 are arranged in order from the top to the bottom on one side of the fuel supplier (not illustrated), and on the other side of the fuel supplier, the fuel battery cells CB1 through CB3 are arranged in order the same as the fuel battery cells CA1 through CA3. In addition, in the example for comparison 1, the fuel battery cells CA1 through CA3 and the fuel battery cells CB1 through CB3 are connected in series in order from CA1 to CA3 or CB1 to CB3, and CA1 and CB1, CA2 and CB2, CA3 and CB3 are electrically connected in parallel.

In order to calculate the output voltages of the fuel batteries, it is assumed that each battery cell structure is 12 cm in height and 9 cm in width, in other words, the long side of each fuel battery cell is 9 cm, and the short side thereof is 4 cm; then, the output voltage V of the fuel battery cells connected in parallel is expressed as below.
V=V0+b/S (3)

where an open voltage (when the output end is open) is represented by V0, S (cm²) represents the total area of the fuel battery cells in contact and connected in parallel, and b is a negative constant, which shows a varying rate of the output voltage V relative to the area S. Here, it is assumed that V0=0.45 V, and b=−0.7 V·cm².

In addition, as shown in FIG. 20A, when the fuel battery is tilted along an arrow in FIG. 20A from a condition in which the fuel battery is installed upright with the battery cell structures being vertically arranged, then when the battery cell structures are tilted from the state in which the battery cell structures are perpendicular to the horizontal plane, the tilt angle θ of the fuel battery is shown in FIG. 20A. It is assumed that the tilt angle θ=0 degrees when CA1 through CA3 are horizontal, and the tilt angle θ=90 degrees when CA1 through CA3 are vertical. For example, considering that the fuel 68 is used and is reduced up to a state in which only one-third of the area of one fuel electrode is in contact with the fuel, for example, the states of the surface 68a of the liquid fuel are shown in FIG. 20A through FIG. 20C.

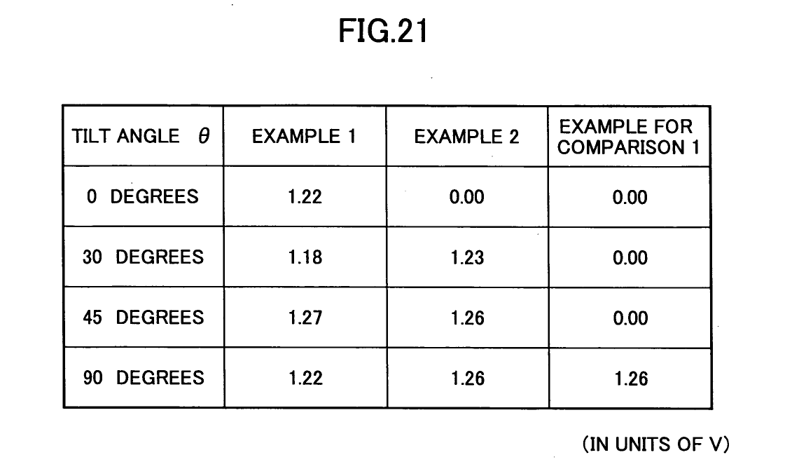

FIG. 21 is a table exemplifying a relationship between the tilt angle θ and the output voltage of the fuel battery.

FIG. 21 shows the output voltages of the fuel battery calculated under the above conditions with the tilt angle θ of the fuel battery being 0 degrees, 30 degrees, 45 degrees, and 90 degrees, respectively. In FIG. 21, the value “0.00 V” indicates that the output voltage of at least one of the fuel battery cells connected in series is zero.

As shown in FIG. 21, in the example for comparison 1, when the tilt angle θ of the fuel battery is 0 degrees, 30 degrees, and 45 degrees, the output voltages of the fuel battery are zero, that is, the power supply is stopped.

In contrast, in the second example, the output voltage of the fuel battery is 0.00 V only when the tilt angle θ of the fuel battery is 0 degrees; when the tilt angle θ of the fuel battery is 30 degrees, 45 degrees, and 90 degrees, the output voltages of the fuel battery are not zero, that is, the power supply is possible. This reveals that power supply is possible in a range wider than the example for comparison 1 under the condition that the fuel is reduced to only one-third.

Further, in the first example, at all of the tilt angles θ =0 degrees, 30 degrees, 45 degrees, and 90 degrees, the power supply is possible, and stoppage of power supply is preventable.

### Third Embodiment

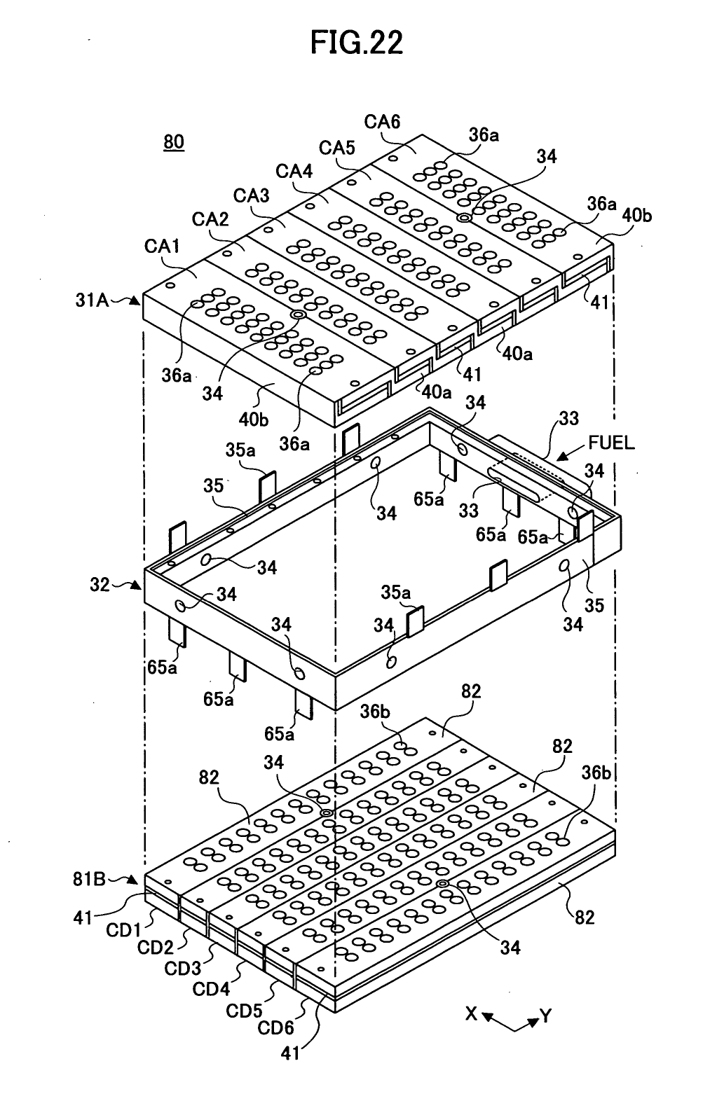

FIG. 22 is an exploded perspective view of a fuel battery 80 according to a third embodiment of the present invention.

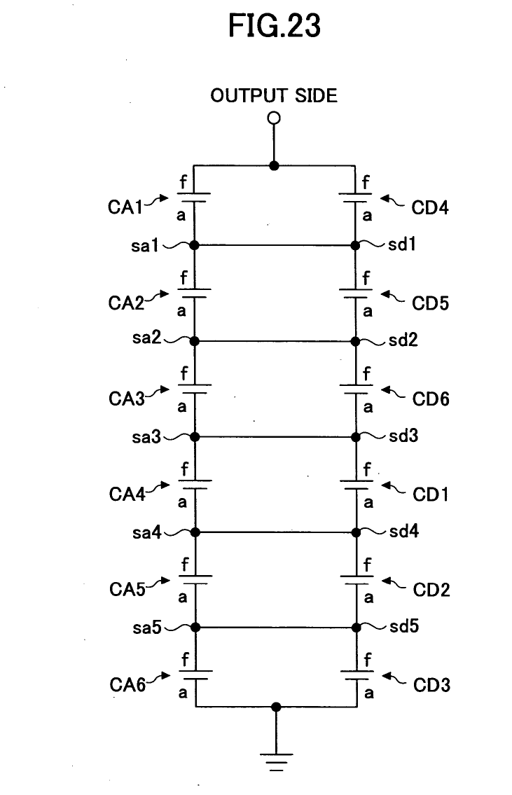

FIG. 23 is a circuit diagram illustrating an equivalent circuit of the fuel battery 80.

In FIG. 22 and FIG. 23, the same reference numbers are assigned to the corresponding elements as those illustrated previously, and overlapping descriptions are omitted.

As shown in FIG. 22 and FIG. 23, briefly speaking, the fuel battery 80 includes the fuel supplier 32 and the battery cell structure 31A and a battery cell structure 81B which are arranged to face each other respectively to sandwich the fuel supplier 32; in the battery cell structure 31A, fuel battery cells CA1 through CA6 are arranged, and in the battery cell structure 81B, fuel battery cells CD1 through CD6 are arranged. In the fuel battery 80, the arrangement direction (the X direction) of the fuel battery cells CD1 through CD6 in the battery cell structure 81B is perpendicular to the arrangement direction (the Y direction) of the fuel battery cells CA1 through CA6 in the battery cell structure 31A. The fuel battery 80 is nearly the same as the fuel battery 60 of the second embodiment but differs from the fuel battery 60 in the order of the serial electrical connection of the fuel battery cells CD1 through CD6 and in the path of parallel connection of the fuel battery cells CA1 through CA6 and the fuel battery cells CD1 through CD6.

In the battery cell structure 81D, the fuel electrode of the fuel battery cell CD4 serves as an output side, and the fuel battery cells CD1 through CD6 are electrically connected with each other in order of the fuel electrode of CD4/the air electrode of CD4—the fuel electrode of CD5/the air electrode of CD5—the fuel electrode of CD6/the air electrode of CD6—the fuel electrode of CD1/the air electrode of CD6—the fuel electrode of CD1/the air electrode of CD1—the fuel electrode of CD2/the air electrode of CD2—the fuel electrode of CD3/the air electrode of CD3.

Further, the fuel battery cells CA1 through CA6 are connected with the fuel battery cells CD1 through CD6 in parallel in the following way, that is, in the battery cell structure 31A and the battery cell structure 81D, connectors sa1 through sa5 and connectors sd1 through sd5 are connected respectively with the m-th ((m is an integer in the range from 1 to 5) connectors from the output side being connected with each other.

In the serial of the fuel battery cells CD1 through CD6 connected in series, the fuel battery cells CD1 through CD6 are connected such that the output side and the grounding side are near the center of the fuel battery cell arrangement, such as the fuel battery cells CD3 and CD4 near the center, instead of the fuel battery cells at the ends of the fuel battery cell arrangement of the battery cell structure 81D, such as the fuel battery cells CD1 and CD6.

With the fuel battery cells being connected in this way, even when the fuel is reduced very much, since the fuel electrode of any one of the fuel battery cells connected in parallel is always in contact with the fuel, the fuel battery 80 can always supply power, that is, it is possible to prevent stoppage of power supply, and even when the area covered of the fuel electrodes of the fuel battery cells is very small, the fuel battery 80 can still supply power regardless of the posture of the fuel battery 80.

In addition, it is preferable that each of the battery cell structure 31A and the battery cell structure 81D is of a square shape. Due to this, it is possible to the change of the output voltage of the fuel battery even when the fuel is reduced very much.

Separators 82 of the fuel battery cells of the battery cell structure 81D are of a parallel plate shape, and the separators 82 are connected through leads 65a.

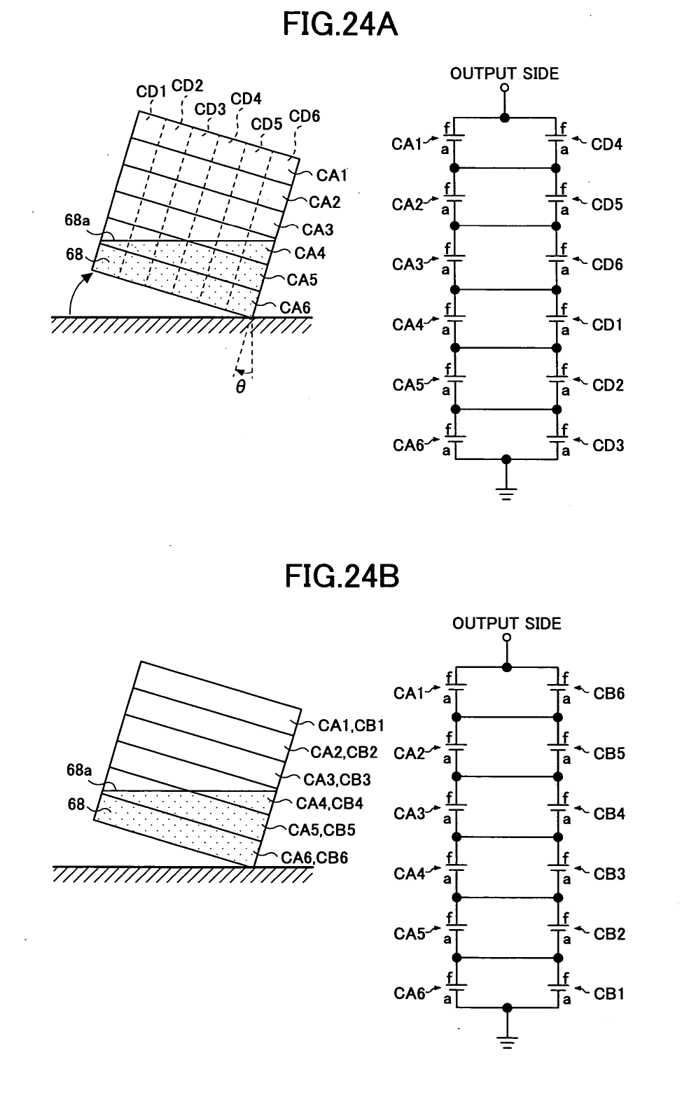

FIG. 24A includes a schematic view illustrating the fuel battery of the third embodiment and a circuit diagram of the equivalent circuit of the fuel battery as an example 3.

FIG. 24B includes a schematic view illustrating the fuel battery of the first embodiment and a circuit diagram of the equivalent circuit of the fuel battery as an example 4.

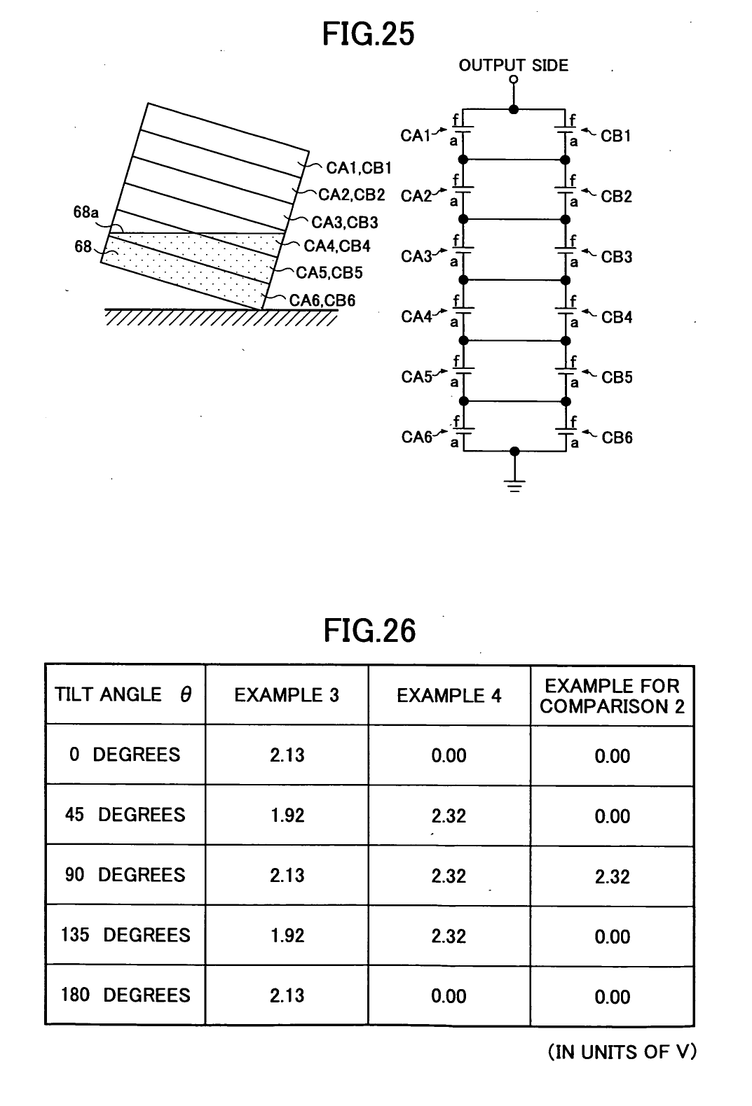

FIG. 25 includes a schematic view illustrating a fuel battery to which the present invention is not applied and a circuit diagram of the equivalent circuit of the fuel battery as an example for comparison 2.

In the fuel batteries of the examples 3 and 4, and in the example for comparison 2, six fuel battery cells CA1 through CA6, or CD1 through CD3, or CB1 through CB3 are arranged on one side of the fuel batteries, and on the right side of FIG. 24A, FIG. 24B, and FIG. 25, the equivalent circuits of the fuel batteries are presented respectively for illustrating the electrical connection relationship.

Referring to FIG. 24A, in the example 3 of the fuel battery according to the third embodiment, the fuel battery cells CA1 through CA6 are arranged in order from the top to the bottom on one side, and the fuel battery cells CD1 through CD6 are arranged to be perpendicular to the arrangement direction of the fuel battery cells CA1 through CA6 on the other side. In addition, in the example 3 of the fuel battery, the fuel battery cells CA1 through CA6 are electrically connected in series in order from CA1 to CA6, the fuel battery cells CD1 through CD6 are electrically connected in series in order of CD4-CD5-CD6-CD1-CD2-CD3; further CA1 and CD4, CA2 and CD5, CA3 and CD6, CA4 and CD1, CA5 and CD2, and CA6 and CD3 are electrically connected in parallel.

Referring to FIG. 24B, in the example 4 of the fuel battery according to the first embodiment, the fuel battery cells CA1 through CA6 are arranged in order from the top to the bottom on one side, and the fuel battery cells CB1 through CB6 are arranged in order in the same direction of the fuel battery cells CA1 through CA6 on the other side. In addition, in the example 4 of the fuel battery, the fuel battery cells CA1 through CA6 are electrically connected in series in order of CA1 to CA6, and the fuel battery cells CB1 through CB6 are electrically connected in series in order of CB6 to CB1, namely, opposite to order of CA1 through CA6. In addition, CA1 and CB6, CA2 and CB5, CA3 and CB4, CA4 and CB3, CA5 and CB2, CA6 and CB1 are electrically connected in parallel.

Referring to FIG. 25, in the example for comparison 2, the fuel battery cells CA1 through CA6 are arranged in order from the top to the bottom on one side, and the fuel battery cells CB1 through CB6 are arranged to in order the same as the fuel battery cells CA1 through CA6 on the other side. In addition, in the example for comparison 2, the fuel battery cells CA1 through CA6 and the fuel battery cells CB1 through CB6 are connected in series in order from CA1 to CA3, or CB1 to CB3, and CA1 and CB1, CA2 and CB2, CA3 and CB3, CA4 and CB4, CA5 and CB5, CA6 and CB6 are electrically connected in parallel.

In order to calculate the output voltages of the fuel batteries, it is assumed that each battery cell structure is of a square shape, which is 10 cm in height and 10 cm in width; hence, the long side of each fuel battery cell is 10 cm and the short side of each fuel battery cell is 1.67 cm, and the output voltage V of the fuel battery cells connected in parallel is expressed by the above equation (3). Further, it is assumed that V0=0.45 V, and b=−0.7 V·cm².

In addition, as shown in FIG. 24A, the tilt angle θ of the fuel battery is shown in FIG. 24A, and the tilt angle θ=0 degrees when CA1 through CA6 are horizontal, and the tilt angle θ=90 degrees when CA1 through CA6 are vertical. For example, considering that the fuel 68 is reduced up to a state in which only one-third of the area of one fuel electrode is in contact with the fuel 68, for example, the states of the surface 68a of the liquid fuel are shown in FIG. 24A, FIG. 24B, and FIG. 25.

FIG. 26 is a table exemplifying a relationship between the tilt angle θ and the output voltage of the fuel battery.

FIG. 26 shows the output voltages of the fuel battery calculated under the above conditions with the tilt angle θ of the fuel battery being 0 degrees, 45 degrees, 90 degrees, 135 degrees, and 180 degrees, respectively. In FIG. 26, the value “0.00 V” indicates that the output voltage of at least one of the fuel battery cells connected in series is zero.

As shown in FIG. 26, in the example for comparison 2, when the tilt angle θ of the fuel battery is 0 degrees, 45 degrees, 135 degrees, and 180 degrees, the output voltages of the fuel battery is zero, that is, the power supply is stopped.

In contrast, in the example 4, the output voltages of the fuel battery is 0.00 V only when the tilt angle θ of the fuel battery is 0 degrees and 180 degrees; when the tilt angle θ of the fuel battery is 45 degrees, 90 degrees, and 135 degrees, the output power is obtained, that is, the power supply is possible. This reveals that power supply is possible in a range wider than the example for comparison 2 under the condition that the fuel is reduced to only one-third.

Further, in the example 3, at all of the tilt angles θ =0 through 180 degrees, the power supply is possible, and thus stoppage of power supply is preventable.

Therefore, with the fuel battery 80 of the third embodiment of the present invention, the power supply is possible even when the fuel is reduced very much, as it is possible to supply power over a long time period when applying power to the electronic devices as shown in the first embodiment.

While the invention has been described with reference to preferred embodiments, the invention is not limited to these embodiments, but numerous modifications could be made thereto without departing from the basic concept and scope described in the claims.

For example, in the first embodiment, it is described that the fuel battery is built in a PDA; however, the fuel batteries according to the above embodiments are not limited to PDA, but can be built in a notebook personal computer, a mobile phone, or other portable terminal devices. Further, the fuel battery according to the present invention is not limited to the usage of being built in the portable terminal devices, but can be connected to the portable terminal devices with cables, or be set in a cradle attached to the portable terminal devices.

As is revealed by the above detailed explanations, according to the present invention, even when the surface of the liquid fuel filling the fuel supplier changes, and some fuel battery cells stop electricity generation or the output power decreases, because of the arrangement of fuel battery cells of the present invention, fuel battery cells supplied with the fuel and thus able to generate electricity are connected in parallel; hence, it is possible to prevent stoppage of power supply or to prevent lowering of output power, and enabling stable power supply.

What is claimed is:

1. A fuel battery, comprising:
a plurality of fuel battery cells each of the cells including a fuel electrode, a solid electrolyte, and an air electrode; and
a fuel supplier that is filled with a liquid fuel and supplies the fuel electrode with the liquid fuel;
wherein
a first battery cell structure and a second battery cell structure are formed on a first surface and a second surface constituting the fuel supplier, each of the first battery cell structure and the second battery cell structure includes n said fuel battery cells arranged from one end of the fuel supplier to another end of the fuel supplier,
in the first battery cell structure, the fuel battery cells are electrically connected in series in order of the arrangement so that the fuel electrode of the fuel battery cell on the one end serves as an output side of the first battery cell structure, and the air electrode of the fuel battery cell on the other end serves as a grounding side of the first battery cell structure,
in the second battery cell structure, the fuel battery cells are electrically connected in series in order opposite to said arrangement order so that the fuel electrode of the fuel battery cell on the other end serves as an output side of the second battery cell structure, and the air electrode of the fuel battery cell on the one end serves as a grounding side of the second battery cell structure,
the first battery cell structure and the second battery cell structure are electrically connected in parallel, and
a connector for electrically connecting an m-th fuel battery cell and an (m+1)-th fuel battery cell from the one end of the first battery cell structure is electrically connected with a connector for electrically connecting an m-th fuel battery cell and an (m+1)-th fuel battery cell from the other end of the second battery cell structure, where n is an integer equal to or greater than 2, and m is an integer having at least one value from 1 to n−1.

2. The fuel battery as claimed in the claim 1, wherein the connector between the m-th fuel battery cell and the (m+1)-th fuel battery cell from the one end of the first battery cell structure is electrically connected with the connector between the m-th fuel battery cell and the (m+1)-th fuel battery cell from the other end of the second battery cell structure for any value of m in the range from 1 to n−1.

3. The fuel battery as claimed in the claim 1, wherein each of the fuel battery cells is of a nearly rectangular planer shape or a nearly prolate elliptical planar shape having a longitudinal direction along a direction perpendicular to a direction from the one end to the other end.

4. The fuel battery as claimed in the claim 3, wherein a direction perpendicular to the arrangement direction of the fuel battery cells extends to an end of the first battery cell structure in the same direction.

5. The fuel battery as claimed in the claims 1, wherein
the fuel supplier is of a flat rectangular solid shape in a thickness direction of the fuel supplier, and
the first battery cell structure and the second battery cell structure are located to face each other in the thickness direction.

6. The fuel battery as claimed in the claim 5, wherein a gas exhaust part formed from a gas permeable film is provided on each side surface of the first battery cell structure, the second battery cell structure, and the fuel supplier to isolate the liquid fuel side from the external gas side.

7. The fuel battery as claimed in the claim 5, wherein the gas exhaust part is arranged to be near two ends of each side surface of the first battery cell structure, the second battery cell structure, and the fuel supplier in a longitudinal direction thereof.

8. The fuel battery as claimed in the claim 5, wherein the gas permeable film is of water repellency.

9. The fuel battery as claimed in the claims 1, wherein
the connector includes a separator for connecting adjacent fuel battery cells, and
one end of the separator is in contact with the fuel electrode or the air electrode of one of the adjacent fuel battery cells, and the other end of the separator is in contact with the air electrode or the fuel electrode of the other one of the adjacent fuel battery cells for electrical connection.

10. The fuel battery as claimed in claim 9, wherein
the separator is formed from a plate-like material, and
a cross section of the separator is of a Z-shape in the arrangement direction.

11. The fuel battery as claimed in claim 9, further comprising:
a ring-shaped sealing member that encloses a stack structure of the fuel electrode, the solid electrolyte, and the air electrode, and is sandwiched by two said separators from the fuel electrode side and the air electrode side.

12. The fuel battery as claimed in claims 9, further comprising:
a plate-like sealing member that separates adjacent two of the separators.

13. A fuel battery, comprising:
a plurality of fuel battery cells each of the cells including a fuel electrode, a solid electrolyte, and an air electrode; and
a fuel supplier that is filled with a liquid fuel and supplies the fuel electrode with the liquid fuel;
wherein
a first battery cell structure and a second battery cell structure are formed on a first surface and a second surface constituting the fuel supplier, each of the first battery cell structure and the second battery cell structure includes n said fuel battery cells,
in the first battery cell structure, the n fuel battery cells are arranged from a first end of the fuel supplier to a second end of the fuel supplier opposite to the first end,
in the second battery cell structure, the n fuel battery cells are arranged from a third end of the fuel supplier to a fourth end of the fuel supplier opposite to the third end in a direction perpendicular to an arrangement direction of the fuel battery cells in the first battery cell structure,
in the first battery cell structure, the fuel battery cells are electrically connected in series in order of the arrangement so that the fuel electrode of the fuel battery cell on the first end side serves as an output side of the first battery cell structure, and the air electrode of the fuel battery cell on the second end side serves as a grounding side of the first battery cell structure,
in the second battery cell structure, the fuel battery cells are electrically connected in series in order of the arrangement so that the fuel electrode of the fuel battery cell on the third end side serves as an output side of the second battery cell structure, and the air electrode of the fuel battery cell on the fourth end side serves as a grounding side of the second battery cell structure, and
a connector for electrically connecting an m-th fuel battery cell and an (m+1)-th fuel battery cell from the first end of the first battery cell structure is electrically connected with a connector for electrically connecting an m-th fuel battery cell and an (m+1)-th fuel battery cell from the third end of the second battery cell structure, where n is an integer equal to or greater than 2, and m is an integer having at least one value from 1 to n−1.

14. The fuel battery as claimed in the claim 13, wherein the connector between the m-th fuel battery cell and the (m+1)-th fuel battery cell from the first end of the first battery cell structure is electrically connected with the connector between the m-th fuel battery cell and the (m+1)-th fuel battery cell from the third end of the second battery cell structure for any value of m in the range from 1 to n−1.

15. The fuel battery as claimed in the claim 13, wherein each of the fuel battery cells is of a nearly rectangular planer shape or a nearly prolate elliptical planar shape having a longitudinal direction along the arrangement direction of the fuel battery cells.

16. The fuel battery as claimed in the claim 13, wherein a direction perpendicular to the arrangement direction of the fuel battery cells extends to an end of the first battery cell structure in the same direction.

17. The fuel battery as claimed in the claim 13, wherein
the fuel supplier is of a flat rectangular solid shape in a thickness direction of the fuel supplier, and
the first battery cell structure and the second battery cell structure are located to face each other in the thickness direction.

18. The fuel battery as claimed in the claim 13, wherein the first battery cell structure and the second battery cell structure are of a nearly square shape.

19. The fuel battery as claimed in the claim 13, wherein a gas exhaust part formed from a gas permeable film is provided on each side surface of the first battery cell structure, the second battery cell structure, and the fuel supplier to isolate a liquid fuel side from an external gas side.

20. The fuel battery as claimed in the claim 13, wherein
the connector includes a separator for connecting adjacent fuel battery cells, and
one end of the separator is in contact with the fuel electrode or the air electrode of one of the adjacent fuel battery cells, and the other end of the separator is in contact with the air electrode or the fuel electrode of the other one of the adjacent fuel battery cells for electrical connection.

21. The fuel battery as claimed in claim 20, wherein
the separator is formed from a plate-like material, and
a cross section of the separator is of a Z-shape in the arrangement direction.

22. A fuel battery, comprising:
a plurality of fuel battery cells each of the cells including a fuel electrode, a solid electrolyte, and an air electrode; and
a fuel supplier that is filled with a liquid fuel and supplies the fuel electrode with the liquid fuel;
wherein
a first battery cell structure and a second battery cell structure are formed on a first surface and a second surface constituting the fuel supplier, each of the first battery cell structure and the second battery cell structure includes n said fuel battery cells,
in the first battery cell structure, the n fuel battery cells are arranged from a first end of the fuel supplier to a second end of the fuel supplier opposite to the first end,
in the second battery cell structure, the n fuel battery cells are arranged from a third end of the fuel supplier to a fourth end of the fuel supplier opposite to the third end in a direction perpendicular to an arrangement direction of the fuel battery cells in the first battery cell structure,
in the first battery cell structure, the fuel battery cells are electrically connected in series in order of the arrangement so that the fuel electrode of the fuel battery cell on the first end side serves as an output side of the first battery cell structure, and the air electrode of the fuel battery cell on the second end side serves as a grounding side of the first battery cell structure,
in the second battery cell structure, the fuel battery cells are electrically connected in series so that the fuel electrode of a first fuel battery cell near a center from the third end serves as an output side of the second battery cell structure, and the air electrode of a second fuel battery cell near the center from the third end but different from the first fuel battery cell serves as a grounding side of the second battery cell structure, and
a connector for electrically connecting an m-th fuel battery cell and an (m+1)-th fuel battery cell from the output side of the first battery cell structure among the fuel battery cells connected in series in the first battery cell structure is electrically connected with a connector for electrically connecting an m-th fuel battery cell and an (m+1)-th fuel battery cell from the output side of the second battery cell structure among the fuel battery cells connected in series in the second battery cell structure, where n is an integer equal to or greater than 4, and m is an integer having at least one value from 1 to n−1.

23. The fuel battery as claimed in the claim 22, wherein the connector between the m-th fuel battery cell and the (m+1)-th fuel battery cell from the output side of the first battery cell structure, and the connector between the m-th fuel battery cell and the (m+1)-th fuel battery cell from the output side of the second battery cell structure are electrically connected for any value of m in the range from 1 to n−1.

24. The fuel battery as claimed in claim 22, wherein the first battery cell structure and the second battery cell structure are of a nearly square shape.
